(19) United States
(12) Patent Application Publication
(10) Pub. No.: US 2024/0026094 A1
(43) Pub. Date: Jan. 25, 2024

(54) METHODS OF PREPARING A COMPOSITE COMPRISING NEVER-DRIED NATURAL RUBBER AND FILLER

(71) Applicant: Beyond Lotus LLC, Wilmington, DE (US)

(72) Inventor: Michael D. Morris, Nashua, NH (US)

(21) Appl. No.: 18/256,273

(22) PCT Filed: Dec. 8, 2021
(86) PCT No.: PCT/US2021/062437

§ 371 Date: Jun. 7, 2023

Related U.S. Application Data
(60) Provisional application No. 63/123,396, filed on Dec. 9, 2020.

(51) Int. Cl. C08J 3/20; C08L 7/02; C08K 3/04; B60C 1/00

(52) U.S. Cl. CPC C08J 3/203; C08L 7/02; C08K 3/04; B60C 1/00; C08J 2307/02

(57) ABSTRACT

Described herein are methods of preparing composites from never-dried natural rubber. Also described are composites made from never-dried natural rubber and filler. A method of preparing a composite in an integrated manufacturing operation is further described which includes producing a never-dried natural rubber from latex recovered from natural latex sources in a latex or rubber manufacturing facility. Products made from the composites disclosed herein are also described.

### FIELD OF THE INVENTION

Disclosed herein are methods of making composites from never-dried natural rubber and filler. Also disclosed are composites prepared from the methods disclosed herein and corresponding vulcanizates.

### BACKGROUND

There is always a desire in the rubber industry to develop methods to disperse filler in elastomer and it is especially desirable to develop methods which can do so efficiently with respect to filler dispersion quality, time, effort, and/or cost.

Natural rubber, used as an elastomer, is generally collected or harvested as a latex emulsion or as a coagulum (e.g. cup lumps). The latex is formed into a coagulum by biological processes or other processes occurring in nature or by using an acid or salt treatment, and then typically washed. The washed coagulum, in the form of ‘crumbs’ or sheets, is dried and supplied to the rubber industry in the form of baled crumb or sheets. Drying the natural rubber can require an immense amount of energy and effort. Further, during the drying process, thermal damage to the natural rubber can occur especially if the drying process is not controlled and monitored.

Numerous products of commercial significance are formed of elastomeric compositions wherein reinforcing filler is dispersed in any of various synthetic elastomers, natural rubber or elastomer blends. Carbon black and silica, for example, are widely used to reinforce natural rubber and other elastomers. It is common to produce a masterbatch, that is, a premixture of reinforcing filler, elastomer, and various optional additives, such as extender oil. Such masterbatches are then compounded with processing and curing additives and upon curing, generate numerous products of commercial significance. Such products include, for example, pneumatic and non-pneumatic or solid tires for vehicles, including the tread portion, including cap and base, undertread, innerliner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

A good dispersion of reinforcing filler in rubber compounds has been recognized as a factor in achieving mechanical strength and consistent elastomer composite and rubber compound performance. Considerable effort has been devoted to the development of methods to improve dispersion quality, and various solutions have been offered to address this challenge. For example, more intensive mixing can improve reinforcing filler dispersion, but can degrade the elastomer into which the filler is being dispersed. This is especially problematic in the case of natural rubber, which is highly susceptible to mechanical/thermal degradation, especially under dry mixing conditions.

As an alternative to dry mixing techniques, it is known to feed elastomer latex or polymer solution and a carbon black or silica slurry to a liquid mixing system, e.g., an agitated tank. Such “liquid masterbatch” techniques can be used with natural rubber latex and emulsified synthetic elastomers, such as styrene butadiene rubber (SBR), or other elastomeric polymers in liquid form. However, while wet mixing techniques have shown promise, batch wet mixing can pose challenges in manufacturing operations. Continuous or semi-continuous techniques for producing liquid masterbatch, such as those disclosed in U.S. Pat. Nos. 6,048,923 and 8,586,651, the contents of which are incorporated by reference herein, have been effective for producing elastomer-filler composites characterized by high quality. However, these processes are limited to liquid forms of rubber such as elastomer latex or solution forms of rubber.

Considering the above, methods to utilize natural rubber without subjecting the natural rubber to full drying processes could be economically beneficial and environmentally beneficial since less energy and processing would occur. Thus, there is a need to develop methods to incorporate filler into natural rubber in a less environmentally impactful way and yet still achieve acceptable or enhanced elastomer composite dispersion quality and functionality from elastomer composite masterbatches, which can translate into acceptable or enhanced properties in the corresponding vulcanized rubber compounds and rubber articles.

### SUMMARY

Disclosed herein are methods of preparing a composite and more specifically relates to methods of preparing a composite using never-dried natural rubber and filler and utilizing one or more mixers.

One aspect provides methods for preparing a composite of elastomer and filler(s), and more particularly, a composite comprising natural rubber and filler(s).

Another aspect provides methods to prepare a composite wherein the starting elastomer is a never-dried (wet) natural rubber. The never-dried natural rubber can comprise rubber and water in the form of a coagulum.

Another aspect is a method of preparing a composite, comprising:
(a) charging a mixer separately with at least a never-dried natural rubber and a filler, wherein the never-dried natural rubber has water present in an amount ranging from 5% to 55% (e.g. moisture level) by weight of the never-dried natural rubber;
(b) in one or more mixing steps, mixing the at least the never-dried natural rubber and the filler to form a mixture, wherein in at least one of said mixing steps conducting said mixing at mixer temperatures controlled by at least one temperature-control means. The mixing further involves removing at least a portion of the water from the mixture by evaporation; and
(c) discharging, from the mixer, the composite comprising the filler dispersed in the natural rubber at a loading of at least 20 phr (or other amounts disclosed herein), and wherein the composite has a water content of no more than 5% by weight based on total weight of said composite.

Another feature provides a method of preparing a composite in an integrated manufacturing operation, comprising:
(a) producing a never-dried natural rubber from latex recovered from natural latex sources in a latex or rubber manufacturing facility;
(b) conveying said never-dried natural rubber to at least one mixer;
(c) charging said at least one mixer with at least a never-dried natural rubber and at least one filler, wherein the never-dried natural rubber has water present in an amount ranging from 5% to 55% by weight of the never-dried natural rubber;
(d) in one or more mixing steps, mixing the at least the never-dried natural rubber and the filler to form a mixture, and in at least one of said mixing steps conducting said mixing at mixer temperatures controlled by at least one temperature-control means, and removing at least a portion of the water from the mixture by evaporation; and
(e) discharging, from the at least one mixer, the composite comprising the filler dispersed in the never-dried natural rubber at a loading ranging from 1 to 100 phr, wherein the composite has a water content of no more than 5% by weight based on total weight of said composite.

With regard to any aspect or method or embodiment disclosed herein, where applicable, the method can further comprise any one or more of the following embodiments: the never-dried natural rubber is a coagulum; the never-dried natural rubber is a coagulum formed from exposing natural rubber latex to air under ambient conditions; the never-dried natural rubber is a coagulum formed from exposing natural rubber latex to a salt or acid or both; the never-dried natural rubber has said water present in an amount ranging from 10% to 40% by weight based on the total weight of the never-dried natural rubber; optionally, the never-dried natural rubber has said water present in an amount ranging from 20% to 30%.

With regard to any aspect or method or embodiment disclosed herein, where applicable, the method can further comprise any one or more of the following embodiments: the filler has a liquid content of less than 10% by weight, based on the weight of the filler, and is in the form of a powder or pellet; the filler is a wet filler comprising a filler wetted with a liquid, wherein the liquid is present in an amount determined as a function of OAN of the filler according to the equation k*OAN/(100+OAN)*100, wherein k ranges from 0.6 to 1.1; the filler is a wet filler comprising a filler wetted with a liquid, the wet filler having a liquid content of at least 10% by weight, based on the weight of the wet filler, and is in the form of a powder, paste, pellet, or cake; the liquid is an aqueous liquid.

With regard to any aspect or method or embodiment disclosed herein, where applicable, the method can further comprise any one or more of the following embodiments: the filler comprises at least one material selected from carbonaceous materials, carbon black, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, coated and treated filler thereof, and combinations thereof; the filler is selected from carbon black, silica, coated and treated filler thereof, and combinations thereof; the treated filler is selected from silicon-treated carbon black, chemically-treated carbon black, and chemically-treated silica; the filler comprises a blend of at least two fillers selected from carbon black, silica, and silicon-treated carbon black; the filler comprises carbon black; the filler comprises silica; the filler comprises silicon-treated carbon black.

With regard to any aspect or method or embodiment disclosed herein, where applicable, the method can further comprise any one or more of the following embodiments: the charging comprises charging at least the never-dried natural rubber to the mixer separately but within 20 minutes of charging the filler to the mixer; the charging comprises charging the mixer with at least a portion of the never-dried natural rubber followed by charging the mixer with at least a portion of the filler; wherein upon charging the mixer with at least a portion of the never-dried natural rubber, the never-dried natural rubber is heated to a temperature of 90° C. or higher prior to charging the mixer with at least a portion of the filler; the charging comprises charging the mixer with at least the filler followed by charging the mixer with the never-dried natural rubber; the charging comprises charging the mixer with at least the filler followed by charging the mixer with the never-dried natural rubber; the charging comprises multiple additions of the filler; wherein during the charging or mixing, the method further comprises adding at least one antidegradant, e.g., the at least one antidegradant is N-(1,3-dimethylbutyl)-N′-phenyl-p-phenylenediamine; the charging further comprises charging the mixer with an additional elastomer that is in addition to said never-dried natural rubber; the additional elastomer is the same as the never-dried natural rubber; the additional elastomer is different from the never-dried natural rubber to form an elastomer composite blend.

With regard to any aspect or method or embodiment disclosed herein, where applicable, the method can further comprise any one or more of the following embodiments: the mixture consists essentially of the never-dried natural rubber and the filler; the mixture consists of the never-dried natural rubber and the filler; the mixture consists essentially of the never-dried natural rubber, the filler, and at least one antidegradant.

With regard to any aspect or method or embodiment disclosed herein, where applicable, the method can further comprise any one or more of the following embodiments: a time period between the start of the mixing and the discharging ranges from 5 min to 30 min, e.g., ranging from 5 min to 15 min; during said mixing the mixer has one or more rotors operating at a tip speed of at least 0.5 m/s for at least 50% of the mixing time, e.g., a tip speed of at least 0.6 m/s for at least 50% of the mixing time; temperature of the at least one temperature-control means can be set and maintained by one or more temperature control units (TCU); the TCU can be set to a temperature ranging from 5° C. to 150° C., from 30° C. to 150° C., from 40° C. to 150° C., or from 50° C. to 150° C., e.g., from 40° C. to 125° C., from 50° C. to 125° C., from 40° C. to 110° C., from 50° C. to 110° C., from 65° C. to 150° C., from 65° C. to 100° C., from 70° C. to 100° C., from 75° C. to 100° C., from 50° C. to 100° C., or from 40° C. to 100° C.

With regard to any aspect or method or embodiment disclosed herein, where applicable, the method can further comprise any one or more of the following embodiments: the mixing of the never-dried natural rubber and the filler forms a mixture in the substantial absence of rubber chemicals at mixer temperatures controlled by at least one temperature-control means; one or more rubber chemicals are absent from the composite discharged in step (c); the removing comprises removing at least 50% by weight of the water from the mixture by evaporation; the removing at least a portion of the water from the mixture further comprises expression, compaction, wringing, or combinations thereof; the mixing is performed in one mixing step; the mixing is performed in two mixing steps; the mixing is performed in two mixing steps and the two mixing steps are performed in the same mixer or in different mixers; the method is a batch process; the method is a continuous process.

With regard to any aspect or method or embodiment disclosed herein, where applicable, the method can further comprise any one or more of the following embodiments: the mixture consists essentially of the solid elastomer and the wet filler; the mixture consists essentially of the solid elastomer, the wet filler, and the antidegradant; the composite consists essentially of the filler dispersed in the elastomer and the antidegradant; the composite consists of the filler dispersed in the elastomer; the composite consists of the filler dispersed in the elastomer and the antidegradant.

With regard to any aspect or method or embodiment disclosed herein, where applicable, the method can further comprise any one or more of the following embodiments: the composite comprises the filler dispersed in the natural rubber at a loading ranging from 20 phr to 100 phr, or from 30 phr to 70 phr, or other loading ranges disclosed herein; the composite discharged has a water content of no more than 2% by weight, e.g., no more than 1% by weight; wherein upon the discharging, said mixer has a temperature ranging from 120° C. to 180° C.; after the discharging, the method further comprising mixing the composite with additional elastomer; the additional elastomer is the same as the never-dried natural rubber; the additional elastomer is different from the never-dried natural rubber to form an elastomer composite blend; after the discharging, the method further comprises at least one additional processing step selected from extruding, calendaring, milling, granulating, baling, compounding, and sheeting.

Another aspect is a method of making a vulcanizate, comprising mixing any of the composites disclosed herein with at least one curing agent and/or curing any of the composites disclosed herein in the presence of at least one curing agent.

Another aspect is a tire component or an article comprising the vulcanizates disclosed herein. The article can be selected from tire treads, undertread, innerliners, sidewalls, sidewall inserts, wire-skim, and cushion gum for retread tires; the article can be selected from hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, and propeller shafts.

It is to be understood that both the foregoing general description and the following detailed description are exemplary and explanatory only and intended to provide a further explanation of the present invention, as claimed.

### DETAILED DESCRIPTION

One aspect relates, in part, to methods of preparing or forming a composite by mixing a never-dried natural rubber with a filler(s). This natural rubber can take the form of a coagulum and can be considered a wet natural rubber, as provided herein.

The most common method for natural rubber production involves forming a rubber coagulum from latex, washing the rubber coagulum, then converting the coagulum to a crumb that is subsequently dried by hot air in a continuous process. The majority of the water is removed in less than half the total drying time. Removal of the final 10% of the water can take a substantial part of the total time. Without wishing to be bound by any theory, in the early stages of drying, water is removed by transport through aqueous channels in the rubber crumb followed by evaporation of moisture from the surface. In the later stages of drying, the aqueous channels become closed and water can only escape by diffusion through the rubber crumb, which can be a slow process. The crumbs of the coagulum are made as small as practically possible to minimize the drying time. Dryer temperature is chosen to balance the need for fast drying with the need to avoid polymer degradation, which can occur at temperatures above 100′C.

A process of mixing a never-dried natural rubber with filler with simultaneous removal of at least a portion of the water can save time, cost, and/or provide a natural rubber with less degradation.

The composite formed by the methods disclosed herein can be considered an uncured mixture of filler(s) and natural rubber(s), optionally with one or more additives, in which the additives are discussed in further detail herein. The composite formed can be considered a mixture or masterbatch. The composite formed can be, as an option, an intermediate product that can be used in subsequent rubber compounding and one or more vulcanization processes. The composite, prior to the compounding and vulcanization, can also be subjected to additional processes, such as one or more holding steps or further mixing step(s), one or more additional drying steps, one or more extruding steps, one or more calendaring steps, one or more milling steps, one or more granulating steps, one or more baling steps, one or more twin-screw discharge extruding steps, or one or more rubber working steps to obtain a rubber compound or a rubber article.

The methods for preparing a composite include the step of charging or introducing into a mixer separately at least a never-dried natural rubber and a filler. “Never-dried natural rubber” as used herein refers to natural rubber that is collected and/or harvested (rubber tapping) from rubber trees (e.g., Hevea latex or Hevea brasiliensis species) and/or from other natural latex sources and that has not been dried below levels disclosed herein. The harvested or collected rubber can take the form of a latex, which is a water-based emulsion or colloidal suspension of rubber particles, or a coagulum, e.g., a coagulum in the form of lumps, such as cup lumps. The harvested natural rubber can be a mixture of latex and coagulum. A coagulum can be formed by exposing the latex to ambient conditions, e.g., allowing the coagulation to occur via processes occurring in nature, such as by exposing the latex to the environment and/or through the action of microorganisms naturally present in the latex. Ambient conditions typically involve the absence of external heat or external chemicals applied to the latex. For example, a coagulum can be formed when latex is exposed to air within ambient temperatures ranging from 15′C to 40′C. Coagulation can occur in a vessel that collects the latex directly from a rubber tree where the vessel remains outdoors or is taken indoors, in either case the coagulum can be formed under ambient conditions.

Alternatively or in addition, the latex can be coagulated by man-made steps, for instance, through the use of an acid treatment, salt treatment, and/or by heating (e.g., exposure to steam). Prior to coagulation, the latex can be preserved by the addition of preservatives known in the art, e.g., ammonia.

The natural rubber can optionally be chemically modified in some manner, either before it is coagulated, or in the wet coagulum stage. For example, it may be treated to chemically or enzymatically modify or reduce various non-rubber components, or the rubber molecules themselves may be modified with various monomers or other chemical groups such as chlorine. Epoxidized natural rubber can be used.

During any one or more of the processes disclosed herein, whether the processes occur in nature or are performed with man-made steps, some water evaporation can occur but the material is still considered a wet, or never-dried, natural rubber. As an option, the never-dried natural rubber that is charged to the mixer (e.g., a coagulum) has water (moisture) present in in an amount ranging from about 5 wt % to about 55 wt %, such as from 15 wt % to about 55 wt % or more, based on the weight of the never-dried natural rubber. Alternatively stated, “never-dried natural rubber” can refer to natural rubber not being dried such that water is present in an amount of 5 wt % or more, e.g., 10 wt % or more or 15 wt %. or more. In other words, the natural rubber is never dried before it is utilized in the methods disclosed herein. Thus, the never-dried natural rubber is not a dried natural rubber that has been baled. A portion of or all of the water (or moisture content) in the never-dried natural rubber can be the water naturally present in the coagulum and originally from the rubber tree or other natural latex source. As an option, a portion or all of the water present in the never-dried rubber can result from a washing step. Some liquid, comprising mainly water, can be exuded from the coagulum either naturally, due to the elastic force provided by the rubber polymer, or by applying pressure to the wet coagulum.

With regard to the never-dried natural rubber that is used and mixed with the filler, the natural rubber can be considered a wet natural rubber or substantially wet natural rubber. For example, the natural rubber has water present (or moisture content) in an amount of 5 wt % or more, 10 wt % or more, 15 wt % or more, based on the total weight of the wet natural rubber, such as 20 wt % or more, 25 wt % or more, 30 wt % or more, 35 wt % or more, or ranging from 5 wt % to 55 wt %, 10 wt % to 55 wt %, 15 wt % to 55 wt %, 15 wt % to wt %, 15 wt % to 45 wt %, 15 wt % to 40 wt %, 20 wt % to 55 wt %, 20 wt % to 50 wt %, 20 wt % to 45 wt %, 20 wt % to 40 wt %, 25 wt % to 55 wt %, 25 wt % to 50 wt %, 25 wt % to 45 wt % wt % to 40 wt %, 25 wt % to 35 wt %, 25 wt % to 30 wt %, 30 wt % to 45 wt %, and the like.

The never-dried natural rubber or coagulum can comprise, consist essentially of, consist of, includes a) coagulated rubber particles and b) non-rubber natural components or constituents and c) water (moisture). The never-dried natural rubber can contain, for instance a) from about 50 wt. % to 80 wt. % (e.g., from about 50 wt. % to 75 wt. %) coagulated rubber particles, b) from about 5 wt % to 15 wt % non-rubber components, and c) from about 15% to 55 wt % water. The non-rubber natural components comprise, consist essentially of, consists of, or include: proteins, fatty acids, carbohydrates, lipids, free amino acids, sugar, organic acids, organic solutes, resins, and inorganic materials. The non-rubber natural components can primarily be proteins, carbohydrates, resins and/or lipids.

The never-dried natural rubber can either be subjected to washing or a washing step can be completely avoided. Thus, the never-dried natural rubber as an option, can be a never-dried and never-washed natural rubber, thereby eliminating the washing step to simplify the process.

As an option, the never-dried natural rubber can be subjected to one or more steps to reduce the amount of water present in the never-dried natural rubber. For instance, prior to the charging in step (a), the never-dried natural rubber can be subjected to expression, extrusion, compaction, and/or wringing, or any combinations thereof to reduce the amount of water while maintaining an amount of water of 5% (or more) by weight.

The methods disclosed herein include the step of charging or introducing a mixer separately with at least a never-dried natural rubber and a filler. The filler (whether dry or wet) and never-dried natural rubber are introduced to the mixer as separate charges and subsequently mixed. The charging can occur in any fashion including, but not limited to, conveying, metering, dumping and/or feeding in a batch, semi-continuous, or continuous flow of the never-dried natural rubber and the filler into the mixer. The never-dried natural rubber and filler are not introduced as a mixture to the mixer. The never-dried natural rubber and filler can be added together or simultaneously but not as a mixture (e.g., not where the filler is pre-dispersed into the natural rubber in which the natural rubber forms all or part (in the case of blends) of a polymeric continuous phase. The charging of the never-dried natural rubber and the charging of the filler can occur all at once, or sequentially, and can occur in any sequence. For example, (a) all never-dried natural rubber is added first, (b) all filler is added first, (c) all never-dried natural rubber is added first with a portion of filler followed by the addition of one or more remaining portions of filler, (d) a portion of never-dried natural rubber is added and then a portion of filler is added, (3) a portion of filler is added and then a portion of never-dried natural rubber is added, or (f) at the same time or about the same time, all or a portion of never-dried natural rubber and all or a portion of filler are added as separate charges to the mixer. The never-dried natural rubber can be charged as one piece or multiple pieces (e.g., lumps) or a bulk particulate material. Multiple pieces of the never-dried natural rubber can be attained by cutting or comminution (e.g., form crumbs) the never-dried elastomer using methods well known in the art. The size of these pieces can have dimensions of at least 100 Linn or at least 1 mm up to 10 cm or higher, up to 5 cm, or up to 1 cm.

As an option, the never-dried natural rubber (all or part) and filler (all or part) can be added to the mixer separately but within 20 minutes of each other or within 15 minutes or within 10 minutes or within 5 minutes, or within 1 minute, within 30 seconds of each other, within 15 seconds of each other, or within 5 seconds of each other.

In typical dry mixing processes in which filler is dispersed in solid natural rubber, the challenge is to ensure the mixing time is long enough to ensure sufficient filler incorporation and dispersion before the natural rubber in the mixture experiences high temperatures and undergoes degradation. In typical dry mix methods, the mix time and temperature are controlled to avoid such degradation and the ability to optimize filler incorporation and dispersion is often not possible.

In addition to reducing drying time and costs with the present methods, another benefit of the present mixing methods is the provision of water in the mixture at the start of mixing, which can allow the batch time and temperature to be controlled beyond that attainable with known dry mixing processes. Other benefits may be attained, such as enhancing filler dispersion and/or facilitating rubber-filler interactions and/or improving rubber compound performance. In general, and as described herein, the mixing process can also be managed by controlling one or more mixer or process parameters.

With respect to the filler, the filler can be wet or dry. If more than one filler is used, all of the fillers can be wet or all can be dry or can be a combination of wet filler and dry fillers.

In their dry state, fillers may contain no or small amounts of liquid (e.g. water or moisture) adsorbed onto its surfaces. For example, carbon black can have 0 wt %, or 0.1 wt % to 1 wt %, or up to 3 wt % or up to 4 wt % of water (moisture) and precipitated silica can have a moisture content of from 4 wt. % to 7 wt. % water, e.g., from 4 wt. % to 6 wt % water. Such fillers are referred to herein as dry or non-wetted fillers. For the wet fillers, water or additional water can be added to the filler and is present on a substantial portion or substantially all the surfaces of the filler, which can include inner surfaces or pores accessible to the liquid. If used, during mixing, at least a portion of this liquid can also be removed by evaporation as the wet filler is being dispersed in the never-dried natural rubber. The wet filler can have a liquid content of at least 10% by weight relative to the total weight of the wet filler, e.g., at least 15%, at least 20%, at least 25%, at least 30%, at least 40%, at least 50% by weight, or from 15% to 99%, from 15% to 95%, from 15% to 90%, from 15% to 80%, from 15% to 70%, from 15% to 60%, from 15% to 65%, from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60%, by weight relative to the total weight of the wet filler. Liquid content of filler can be expressed as weight percent: 100*[mass of liquid]/[mass of liquid+mass of dry filler].

With respect to the wet filler, in one embodiment, the wet filler has the consistency of a solid. As an option, a dry filler is wetted only to an extent such that the resulting wet filler maintains the form of a powder, particulates, pellet, cake, or paste, or similar consistency and/or has the appearance of a powder, particulates, pellet, cake, or paste. The wet filler does not flow like a liquid (at zero applied stress). As an option, the wet filler can maintain a shape at 25° C. when molded into such a shape, whether it be the individual particles, agglomerates, pellets, cakes, or pastes. In another embodiment, the wet filler can be a slurry. In yet another embodiment, the wet filler is not a slurry of filler and does not have the consistency of a liquid or slurry.

The liquid used to wet the filler can be, or include, an aqueous liquid, such as, but not limited to, water. The liquid can include at least one other component, such as, but not limited to, a base(s), an acid(s), a salt(s), a solvent(s), a surfactant(s), a coupling agent(s), and/or a processing aid(s) and/or any combinations thereof. More specific examples of the component are NaOH, KOH, acetic acid, formic acid, citric acid, phosphoric acid, sulfuric acid, or any combinations thereof. For example, the base can be selected from NaOH, KOH, and mixtures thereof, or the acids can be selected from acetic acid, formic acid, citric acid, phosphoric acid, or sulfuric acid, and combinations thereof. The liquid can be or include a solvent(s) that is immiscible with the elastomer used (e.g., alcohols such as ethanol). Generally, the liquid consists of from about 80 wt % to 100 wt % water or from 90 wt % to 99 wt % water based on the total weight of the liquid.

As an option for preparing wet filler, the charging can be such that dry filler is introduced into the mixer and wetted by adding the liquid (e.g., water, either sequentially or simultaneously or near simultaneously) to form the wet filler in the mixer, and then the never-dried natural rubber can be added to the mixer. The introduction of dry filler to be optionally wetted can be performed with all of the filler intended to be used or a portion thereof.

The combining of the never-dried natural rubber with filler forms a mixture during the mixing step(s). The method further includes, in one or more mixing steps, conducting said mixing wherein at least a portion of the water is removed by evaporation or an evaporation process that occurs during the mixing. The water present in the never-dried natural rubber is capable of being removed by evaporation (and at least a portion is capable of being removed under the recited mixing conditions). While other volatiles may be present in the never-dried natural rubber and may or may not evaporate during mixing, the volatile portion of a never-dried natural rubber generally is water or a major component of the volatile component is water. Thus, the overall volatile content has the boiling point of water or within a few degrees thereof. The water in the never-dried natural rubber can be distinguished from oils (e.g., extender oils, process oils, and resins) which can be present during at least a portion of the mixing as such oils are meant to be present in the composite that is discharged and thus, do not evaporate during a substantial portion of the mixing time.

With regard to mixing, the mixing can be performed in one or more mixing steps. Mixing commences when at least the never-dried natural rubber and filler are charged to the mixer and energy is applied to a mixing system that drives one or more rotors of the mixer. The one or more mixing steps can occur after the charging step is completed, or can overlap with the charging step for any length of time. For example, a portion of the never-dried natural rubber and/or filler can be charged into the mixer before or after mixing commences. The mixer can then be charged with one or more additional portions of the never-dried natural rubber and/or filler. For batch mixing, the charging step is completed before the mixing step is completed. By “one or more mixing steps,” it is understood that a first mixing step can comprise mixing at mixer temperatures controlled by at least one temperature-control means, followed by further mixing steps prior to the discharging.

As indicated, during the one or more mixing steps disclosed herein, at least some water present in the mixture and/or never-dried natural rubber introduced is removed at least in part by evaporation. As an option, the majority (by wt. %) of any water removed from the mixture occurs by evaporation. For example, at least 50 wt. % of water is removed by evaporation, based on total weight of water removed during the mixing. The total weight of water removed can be determined from the difference between water present in the never-dried natural rubber and any wet filler used, and any water remaining in the composite when discharged from the mixer plus any water present in, or drained from, the mixer when the composite is discharged from the mixer. For example, when the composite is discharged, additional water (e.g., unevaporated water) may also be discharged, either with or within the composite or through outlets provided in the mixer. Water removal by evaporation can represent at least 30 wt. %, at least 40 wt. %, at least 50 wt %, at least 60 wt %, at least 70 wt %, at least 80 wt %, or from 51 wt % to 100 wt %, from 51 wt % to 95 wt %, from 51 wt % to 90 wt %, from 51 wt % to 80 wt %, from 51 wt % to 70 wt %, from 60 wt % to 100 wt %, from 60 wt % to 95 wt %, from 60 wt % to 90 wt %, or from 60 wt % to 80 wt % of the total water contained in the never-dried natural rubber (and any optional wet filler) that is charged to the mixer.

As an option, the one or more mixing steps can further remove a portion of the liquid from the mixture by expression, compaction, and/or wringing, or any combinations thereof. Alternatively, a portion of the liquid can be drained from the mixer after or while the composite is discharged.

With regard to the mixer that can be used in any of the methods disclosed herein, any suitable mixer can be utilized that is capable of combining (e.g., mixing together or compounding together) a filler with the wet natural rubber. The mixer(s) can be a batch mixer or a continuous mixer. A combination of mixers and processes can be utilized in any of the methods disclosed herein, and the mixers can be used sequentially, in tandem, and/or integrated with other processing equipment. The mixer can be an internal or closed mixer or an open mixer, or an extruder or a continuous compounder or a kneading mixer or a combination thereof. The mixer can be capable of incorporating filler into natural rubber and/or capable of dispersing the filler in the natural rubber and/or distributing the filler in the natural rubber. Any one or combination of commercial mixers to produce rubber compounds can be used in the present methods.

The mixer can be capable of batch processing, continuous processing, or semi-continuous processing. The mixer can have any chamber capacity. An internal mixer generally includes an enclosed mixing chamber. For batch mixers, the chamber capacity can be at least 1 L, at least 2 L, at least 5 L, at least 10 L, at least 20 L, at least 50 L, at least 100 L, at least 250 L, at least 300 L, at least 600 L, or at least 1000 L, such as from 1 L to 1500 L, 10 L to 1200 L, 10 L to 1000 L, 10 L to 750 L, 10 L to 500 L, 10 L to 300 L, 10 L to 100 L, 20 L to 1500 L, 20 L to 1200 L, 20 L to 1000 L, 20 L to 750 L, 20 L to 500 L, 20 L to 300 L, 20 L to 100 L, 50 L to 1500 L, 50 L to 1200 L, 50 L to 1000 L, 50 L to 750 L, 50 L to 500 L, 50 L to 300 L, or 50 L to 100 L.

The top of a typical batch mixing chamber can be raised and lowered by a pneumatic or hydraulic piston, commonly referred to as a “floating weight” or a “ram”. The ram operates within a housing known as the “feed hopper,” which has a charge door, through which the materials to be mixed are introduced. The ram is raised to feed the materials (e.g., at least wet natural rubber and filler) and lowered to apply pressure to the mixture and confine the mixture within the mixing chamber. Typically, the fill factor of the batch and the ram pressure are selected so the ram can reach its lowermost position to minimize the clearance between the ram and the rotors, which can enable good filler dispersion. The vertical distance of the ram above its minimum position is known as the “ram deflection.” The bottom of a typical batch mixer can be lowered on a pivot and is known as the “drop door”. It is used to discharge or “dump” the contents of the mixer.

The mixer can have one or more rotors (at least one rotor). For example, each rotor can rotate inside its own cylindrical chamber, which can be connected to the chamber(s) of the other rotor(s). Typically, for a batch mixer, two rotors are utilized. The bodies of the one or more rotors are attached to shafts and can form one integral component. The shafts are controlled by a mixing system to which energy (electrical energy) is applied. A rotor can be considered a device that imparts energy to the mixture and/or the components that form the mixture. The at least one rotor or the one or more rotors can be screw-type rotors, intermeshing rotors, tangential rotors, kneading rotor(s), rotors used for extruders, a roll mill that imparts significant total specific energy, or a creping mill. Generally, one or more rotors are utilized in the mixer, for example, the mixer can incorporate one rotor (e.g., a screw type rotor), two, four, six, eight, or more rotors. Sets of rotors can be positioned in parallel and/or in sequential orientation within a given mixer configuration.

The water that evaporates from the mixture can leave the mixer in one case from a gap between the ram and the body and/or a port or outlet or vent designed to release evaporated water (e.g., steam). For example, in continuous mixers (such as devolatilizing extruders), the evaporated water can be released through vent stuffers or through a piston that periodically clears materials (e.g., evaporated water) through vents or outlets or ports.

The process can utilize one or more mixing steps and/or one or more mixers. For example, mixing the at least never-dried natural rubber and particulate filler to form a mixture, removing at least a portion of the water from the mixture by evaporation, and discharging from the mixture the composite having a water content of no more than 5% by weight can occur as one mixing step in one mixer. In another example, a first mixing step comprises mixing the at least never-dried natural rubber and particulate filler to form a mixture, and the second mixing step comprises discharging from the mixture the composite having a water content of no more than 5% by weight. In this option, the first and second mixing steps can be performed in the same or different mixers. In yet another example, mixing the at least never-dried natural rubber and particulate filler to form a mixture, removing at least a portion of the water from the mixture by evaporation, and discharging from the mixture the composite having a water content of no more than 5% by weight can occur as one mixing step, and a second mixing step (in the same or a second mixer) can be performed to further dry the composite mixer. In other words, the process can include using more than one mixer such that the mixture is mixed in a first mixer in a first mixing step and then taken out and charged into a second mixer in a second mixing step, and so on as desired. Each mixer, if more than one is utilized, can be the same or different from the other mixers that are used in the method. For example, the composite can be discharged from a first mixer and otherwise conveyed to a second mixer. In another example, the composite can be discharged from a mixer and then charged back to the same mixer (e.g., after allowing to cool). These processes, which can be known as multi-stage mixing, can be repeated as many times as needed. Each stage can be mixed with the same or one or more different operating parameters.

In certain embodiments, in at least one of said mixing steps, the method comprises conducting said mixing at mixer temperatures controlled by at least one temperature-control means. Controlling mixer temperatures refers to controlling temperatures of at least one surface of the mixer. As an option, mixer temperatures can be controlled during both the charging and at least one of the mixing steps. The temperature-control means can be a temperature-controlling device on or within the mixer or otherwise associated with the mixer (e.g., connected to the mixer) that heats or cools at least one surface, or one or more parts of the mixer.

The temperature-control means can be, but is not limited to, the flow or circulation of a heat transfer fluid through channels in one or more parts of the mixer. For example, the heat transfer fluid can be water or heat transfer oil. For example, the heat transfer fluid can flow through the rotors, the mixing chamber walls, the ram, and the drop door. In other embodiments, the heat transfer fluid can flow in a jacket (e.g., a jacket having fluid flow means) or coils around one or more parts of the mixer. As another option, the temperature control means (e.g., supplying heat) can be electrical elements embedded in the mixer. The system to provide temperature-control means can further include means to measure either the temperature of the heat transfer fluid or the temperature of one or more parts of the mixer. The temperature measurements can be fed to systems used to control the heating and cooling of the heat transfer fluid. For example, the desired temperature of at least one surface of the mixer can be controlled by setting the temperature of the heat transfer fluid located within channels adjacent one or more parts of the mixer, e.g., walls, doors, rotors, etc.

The temperature of the at least one temperature-control means can be set and maintained, as an example, by one or more temperature control units (“TCU”). In the case of temperature-control means incorporating heat transfer fluids, the temperature can be an indication of the temperature of the fluid itself.

The mixer can have thermocouples located at different parts of the mixer to provide a more accurate measurement of the temperature of the mixer part(s) or the mixture. The temperature of the at least one surface may deviate from the temperature set in the TCU but should still reasonably approximate that temperature.

The mixer can have more than one temperature-control means or devices, such as two, three, or more that each provide a region of temperature control within the mixer or section of the mixer. The one or more temperature-control means or device(s) can be located at any portion or part of the mixer(s). For instance, a wall(s) or all walls of the mixer or mixer chamber, and/or the ram, and/or the drop door(s), and/or the one or more rotors, and/or extrusion head can be temperature controlled to form one or multiple temperature-control regions. As an option, the at least one temperature-control means heats at least a wall of the mixer.

As an option, the TCU can be set to a temperature ranging from 5° C. to 150° C., from 30° C. to 150° C., from 40° C. to 150° C., or from 50° C. to 150° C., e.g., from 40° C. to 125° C., from 50° C. to 125° C., from 40° C. to 110° C., from 50° C. to 110° C., from 65° C. to 150° C., from 65° C. to 100° C., from 70° C. to 100° C., from 75° C. to 100° C., from 50° C. to 100° C., or from 40° C. to 100° C. Other ranges are possible with equipment available in the art.

Compared to dry mixing, under similar situations of filler type, elastomer type, and mixer type, the present processes can allow higher energy input. Controlled removal of the water from the never-dried natural rubber enables longer mixing times and consequently improves the dispersion of the filler. As described herein, the present process provides operating conditions that balance longer mixing times with evaporation or removal of water in a reasonable amount of time.

Other operating parameters to be considered include the maximum pressure that can be used. Pressure affects the temperature of the filler and rubber mixture. If the mixer is a batch mixer with a ram, the pressure inside the mixer chamber can be influenced by controlling the pressure applied to the ram cylinder.

As an option, the process comprises, in at least one of the mixing steps, conducting the mixing such that one or more rotors operate at a tip speed of at least m/s for at least 50% of the mixing time. The energy inputted into the mixing system is a function, at least in part, of the speed of the at least one rotor and rotor type. Tip speed, which takes into account rotor diameter and rotor speed, can be calculated according to the formula:

Tip speed, m/s=π×(rotor diameter, m)×(rotational speed, rpm)/60.

As tip speeds can vary over the course of the mixing, as an option, the tip speed of at least 0.4 m/s, at least 0.5 m/s, or at least 0.6 m/s is achieved for at least 50% of the mixing time, e.g., at least 60%, at least 70%, at least 75%, at least 80%, at least 85%, at least 90%, at least 95%, or substantially all of the mixing time. The tip speed can be at least 0.5 m/s, at least 0.6 m/s, at least 0.7 m/s, at least 0.8 m/s, at least 0.9 m/s, at least 1.0 m/s, at least 1.1 m/s, at least 1.2 m/s, at least 1.5 m/s or at least 2 m/s for at least 50% of the mixing time, or other portions of the mixing listed above. The tip speeds can be selected to minimize the mixing time, or can be from 0.6 m/s to 10 m/s, from 0.6 m/s to 8 m/s, from 0.6 to 6 m/s, from 0.6 m/s to 4 m/s, from 0.6 m/s to 3 m/s, from 0.6 m/s to 2 m/s, from 0.7 m/s to 4 m/s, from 0.7 m/s to 3 m/s, from 0.7 m/s to 2 m/s, from 0.7 m/s to 10 m/s, from 0.7 m/s to 8 m/s, from 0.7 to 6 m/s, from 1 m/s to 10 m/s, from 1 m/s to 8 m/s, from 1 m/s to 6 m/s, from 1 m/s to 4 m/s, from 1 m/s to 3 m/s, or from 1 m/s to 2 m/s, (e.g., for at least 50% of the mixing time or other mixing times described herein). In the alternative or in addition, the tip speeds can be selected to maximize throughput. The time/throughput considerations may take into account that as mixing time decreases, the liquid level in the discharged composite may increase. In certain situations, it may be beneficial to perform the mixing at high tip speed for higher throughput balanced with the desired liquid content of the discharged composite, (e.g. excessively high tip speeds may cause shorter residence or mixing times that may not allow sufficient filler dispersion or sufficient removal of the liquid from the composite).

In any methods disclosed herein, the discharging step from the mixer occurs and results in a composite comprising the filler dispersed in the natural rubber at a loading of at least 20 phr, e.g., from 20 to 250 phr, or other loading disclosed herein. As an option, discharging occurs on the basis of a defined mixing time. The mixing time between the start of the mixing and discharging can be about 1 minute or more, such as from about 1 minute to 40 minutes, from about 1 minute to 30 minutes, from about 1 minute to 20 minutes, or from 1 minute to 15 minutes, or from 3 minutes to 30 minutes, from 5 minutes to 30 minutes, or from 5 minutes to 20 minutes, or from 5 minutes to 15 minutes, or from 1 minute to 12 minutes, or from 1 minute to 10 minutes or other times. Alternatively, for batch internal mixers, ram down time can be used as a parameter to monitor batch mixing times, e.g., the time that the mixer is operated with the ram in its lowermost position e.g., fully seated position or with ram deflection as described herein. Ram down time can be less than 30 min., less than 15 min., less than 10 min., or ranges from 3 min. to 30 min or from 5 min. to 15 min, or from 5 min. to 10 min. As an option, discharging occurs on the basis of dump or discharge temperature. For example, the mixer can have a dump temperature ranging from 120° C. to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

The methods further include discharging from the mixer the composite that is formed. The discharged composite can have a water content of no more than 5% by weight based on the total weight of the composite, as outlined in the following equation:

Water content of composite %=100*[mass of water]/[mass of water+mass of dry composite]

In any of the methods disclosed herein, the discharged composite can have a water content of no more than 5% by weight based on total weight of the composite (e.g., where the filler also comprises water), no more than 3%, no more than 2%, or no more than 1% by weight, based on the total weight of the composite. This amount can range from 0.1% to 5%, from 0.5% to 5%, from 1% to 5%, from 0.1% to 3%, from 0.5% to 3%, or from 1% to 3% by weight based on the total weight of the composite discharged from the mixer at the end of the process.

In any of the methods disclosed herein, water content (moisture content) in the composite can be measured as weight % of water present in the composite based on the total weight of the composite. Any number of instruments are known in the art for measuring water content in rubber materials, such as a coulometric Karl Fischer titration system, or a moisture balance, e.g., from Mettler (Toledo International, Inc., Columbus, OH). As explained herein, while the never-dried natural rubber can have water present, the filler used can also be a wet filler, and these other sources at the start of the process can provide or contribute to the amount of water in the mixture above the amount provided by the never-dried natural rubber alone.

In any of the methods disclosed herein, while the discharged composite can have a water content of 5% by weight or less, there optionally may be water present in the mixer which is not held in the composite that is discharged. This excess water is not part of the composite and is not part of any water content calculated for the composite.

In any of the methods disclosed herein, the total water content of the material charged into the mixer is higher than the water content of the composite discharged at the end of the process. For instance, the water content of the composite discharged can be lower than the liquid content of the material charged into the mixer by an amount of from 10% to 99.9% (wt % vs wt %), from 10% to 95%, or from 10% to 50%.

In typical dry mixing processes, one or more rubber chemicals (e.g., processing aids) are charged early in the mix cycle to aid incorporation of the filler. Thus, rubber chemicals can be essential, yet they can interfere with binding or interaction between filler and elastomer surfaces and have a negative impact on vulcanizate properties. It has been discovered that the use of a never-dried natural rubber enables mixing in the absence of, or substantial absence of, such rubber chemicals.

Accordingly, as an option any method disclosed herein can comprise charging a mixer with never-dried natural rubber and filler and, in one or more mixing steps, mixing the never-dried natural rubber and the filler to form a mixture in the substantial absence of rubber chemicals at mixer temperatures controlled by at least one temperature-control means. Optionally the process further comprises adding at least one additive selected from anti-degradants and coupling agents during the charging or the mixing, i.e., during the one or more mixing steps. Examples of such anti-degradants (e.g. anti-oxidants) and coupling agents are described herein. As an option, the mixture consists essentially of the solid elastomer and the wet filler; the mixture consists essentially of the solid elastomer, the wet filler, and the antidegradant; the composite consists essentially of the filler dispersed in the elastomer and the antidegradant; the composite consists of the filler dispersed in the elastomer; the composite consists of the filler dispersed in the elastomer and the antidegradant.

As defined herein, “substantial absence” refers to a process wherein the charging step and the one or more mixing steps can be carried out in the presence of the one or more rubber chemicals in an amount less than 10% by weight of the total amount of rubber chemicals ultimately provided in a vulcanizate prepared from the composite, e.g., the cured composite, or the charging step and the one or more mixing steps can be carried out in the presence of the one or more rubber chemicals in an amount less than 5% or less than 1% by weight of the total amount of rubber chemicals ultimately in the composite. As it is optional to include the rubber chemicals in the composite, a suitable measure of determining “substantial absence” of the one or more rubber chemicals is to determine the amount targeted in the vulcanizate prepared from the composite, e.g., after curing the composite. Thus, a nominal amount of the one or more rubber chemicals may be added during said charging or mixing but not an amount sufficient to interfere with filler-elastomer interaction. As a further example of “substantial absence,” the charging and mixing can be carried out in the presence of the one or more rubber chemicals in an amount or loading of 5 phr or less, 4 phr or less, 3 phr or less, 2 phr or less, 1 phr or less, or 0.5 phr or less, 0.2 phr or less, 0.1 phr or less, based on the resulting vulcanizate.

In any embodiment disclosed herein, as an option, after the mixing of at least the never-dried natural rubber and filler has commenced and prior to the discharging step, the method can further include adding at least one anti-degradant to the mixer so that the at least one anti-degradant is mixed in with the never-dried natural rubber and filler. The optional adding of the anti-degradant(s) can occur at any time prior to the discharging step. For instance, the adding of the anti-degradant(s) can occur prior to the composite being formed and having a water content of 10 wt % or less, or 5 wt % or less. Examples of an anti-degradant that can be introduced is N-(1,3-dimethylbutyl)-N′-phenyl-p-phenylenediamine (6PPD), and others are described in other sections herein. The anti-degradant can be introduced in an amount ranging from 1% to 5%, from 0.5% to 2%, or from 0% to 3% based on the weight of the composite that is formed. Anti-degradants added during the charging step or the mixing step may help prevent elastomer degradation during the mixing; however, due to the presence of the water in the mixture, the rate of degradation of the elastomer is lower compared to dry mix processes and the addition of anti-degradant can be delayed.

After the composite is formed and discharged, the method can include the further optional step of mixing the composite with additional elastomer to form a composite comprising a blend of elastomers. The “additional elastomer” can be additional natural rubber or can be an elastomer that is not natural rubber such as functionalized natural rubber, synthetic elastomers (e.g., styrene butadiene rubbers (SBR, such as solution SBR (SSBR), emulsion SBR (ESBR), or oil-extended SSBR (OESSBR)), functionalized styrene butadiene rubber, hydrogenated SBR, polybutadiene (BR) and polyisoprene rubbers (IR), functionalized polybutadiene rubber, ethylene-propylene rubber (e.g., EPDM), isobutylene-based elastomers (e.g., butyl rubber), polychloroprene rubber (CR), nitrile rubbers (NBR), hydrogenated nitrile rubbers (HNBR), polysulfide rubbers, polyacrylate elastomers, fluoroelastomers, perfluoroelastomers, and silicone elastomers). Other synthetic polymers include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof. Blends of two or more types of elastomers (blends of first and second elastomers), including blends of synthetic and natural rubbers or with two or more types of synthetic or natural rubber, may be used as well.

The mixer can be charged with two or more charges of different elastomer to form a composite blend. For example, the mixer can be charged with the never-dried natural rubber and at least one additional elastomer, where the at least one additional elastomer is also a coagulum or a solid elastomer (e.g., having less than 5% water). Alternatively, the mixer can be charged with an elastomer blend. As another option, the process can comprise mixing the discharged composite with additional elastomer to form the blend. The composite discharged (e.g., after single-stage or two or multi-stage mixing) can have a moisture content of no greater than 5%, 3%, or 2% by weight relative to the weight of the composite when blending with one or more additional elastomers (e.g., a composite comprising carbon black and natural rubber can be blended with synthetic elastomers such as BR or SBR). Further, both elastomers and fillers (wet or dry, such as wet or dry carbon black and/or silica and/or silicon-treated carbon black) can be combined with the composite.

As another option, a composite comprising a filler (e.g., carbon black and/or silica) and natural rubber prepared according to the presently disclosed methods can be combined with a masterbatch containing natural rubber and/or synthetic polymers made by any method known in the art, such as by known dry mixing or solvent masterbatch processes. For example, silica/elastomer masterbatches can be prepared as described in U.S. Pat. Nos. 9,758,627 and 10,125,229, or masterbatches from neodymium-catalyzed polybutadienes as described in U.S. Pat. No. 9,758,646, the disclosures of which are incorporated by reference herein. The masterbatch can have a fibrous filler, such as poly(p-phenylene terephthalamide) pulp, as described in U.S. Pat. No. 6,068,922, the disclosure of which is incorporated by reference herein. Masterbatches can have fillers such as graphenes, graphene oxides, reduced graphene oxides, or densified reduced graphene oxide granules, carbon nanotubes, single-wall carbon nanotubes, multi-wall carbon nanotubes, and carbon nanostructures, in which masterbatches of the latter are disclosed in U.S. Pat. No. 9,447,259, and PCT Appl. No. PCT/US2021/027814, the disclosures of which are incorporated by reference herein. Other suitable masterbatches can include the composites prepared from mixing wet filler and solid elastomer, as described in PCT Publ. No. WO 2020/247663, the disclosures of which is incorporated by reference herein. For example, the masterbatch can have a filler such as carbon black and/or silica and an elastomer such as natural rubber and/or SBR and/or butadiene rubber. Commercially available masterbatches can also be used, e.g., commercially available masterbatches such as Emulsil™ silica/SBR masterbatch or Emulblack™ carbon black/SBR masterbatch (both available from Dynasol group).

Exemplary masterbatches comprising elastomer blends include: blends of natural rubber with synthetic, bio-sourced, and/or functionalized elastomers (e.g., SSBR, ESBR, BR) where the filler can be selected from one or more of carbon black, silica, and silicon-treated carbon black.

Any of the methods disclosed herein relates, in part, to methods of preparing a composite that involves at least two mixing steps or stages. These two (or more) mixing steps can be considered multi-step or multi-stage mixing with a first mixing step or stage and at least a second mixing step or stage. One or more of the multi-stage mixing processes can be batch, continuous, semi-continuous, and combinations thereof.

For the multi-stage process, the methods for preparing the composite include the step of charging or introducing into a first mixer at least a) never-dried natural rubber and b) one or more fillers. The combining of the never-dried natural rubber with filler forms a mixture or composite during this mixing step(s), which can be considered as a first mixing step or stage. The method further includes mixing the mixture, in this first mixing step, to an extent that at least a portion of the water is removed by evaporation or an evaporation process that occurs during the mixing. This first mixing step or stage is conducted using one or more of the processes described earlier that forms a composite with the understanding that, after completion of the first mixing step or stage, it is not necessary for the mixture that is discharged from the mixer after the first mixing step (e.g., a discharged mixture) to have a water content of no more than 5 wt %. In other words, with the multi-stage process(es), the mixture resulting from the completion of the first mixing from the first mixer (or first mixing step) can have a water content above 5 wt % but does have a water content that is reduced (by wt %) as compared to the water content of the combined never-dried natural rubber and filler at the start of the first mixing step. The method then includes mixing or further mixing the mixture in at least a second mixing step or stage utilizing the same mixer (i.e., the first mixer) and/or utilizing a second mixer(s) that is different from the first mixer. The method then includes discharging from the final mixer the composite that is formed such that the composite has a water content of no more than 5% by weight based on the total weight of the composite.

In the multi-stage processes, a second mixing step (second stage mix) can comprise charging the mixer with other components in addition to the mixture discharged from the first mixing step. For example, the method can comprise charging additional filler, such as dry filler, wet filler (e.g., having a liquid present in an amount of at least 15% by weight), or a blend thereof prior to or during the second mixing step. The additional filler can be the same or different from the filler already present in the mixture, e.g., any of the additional fillers disclosed herein. For example, the mixture discharged from the first mixer can be considered a masterbatch in which either all or a portion is combined with additional filler. For example, wet or dry carbon black, silica, silicon-treated carbon black (and blends thereof) can be added to the mixture discharged from the first mixing step, such as a mixture comprising carbon black and natural rubber.

For instance, the first mixer can be a tangential mixer or an intermesh mixer and the second mixer can be a tangential mixer, an intermesh mixer, an extruder, a kneader, or a roll mill.

For instance, the first mixer can be an internal mixer and the second mixer can be a kneader, a single screw extruder, a twin-screw extruder, a multiple-screw extruder, a continuous compounder, or a roll mill.

For instance, the first mixer can be a first tangential mixer, and the second mixer can be a second (different) tangential mixer.

For instance, the first mixer is operated with a ram, and the second mixer is operated without a ram.

In any of the multi-stage processes disclosed herein, the final discharged composite (e.g., the composite discharged after the second or third, or more mixing step) can have a water content of 5% by weight or less, such as 5 wt. % or less, or 2 wt. % or less, or 1 wt. % or less, based on the total weight of the composite. This amount can be from about 0.1 wt. % to 5 wt. % or from about 0.5 wt. % to 5 wt. % or from about 0.5 wt. % to about 4 wt. %, based on the total weight of the composite discharged from the mixer at the end of the process.

In any of the multi-stage processes disclosed herein, the total water content of the material charged into the mixer at the start of the process is higher than the water content of the composite when the first mixing step is stopped. For instance, the water content of the mixture when the first mixing step is stopped can be from 10% to 50% lower (wt. % vs wt. %), or can be 25% or more lower, or 10% or more lower than at the start of the first mixing step.

Further, in the multi-stage processes disclosed herein, the total water content of the mixture at the end of the first mixing step is higher than the water content of the final composite discharged at the end of the process (after the last mixing step). For instance, the water content of the composite discharged can be from 10% to 50% lower (wt. % vs wt. %), or can be 25% or more lower, or 10% or more lower than after the completion of the first mixing step.

In any of the multi-stage processes disclosed herein, upon being discharged from the last mixer, the temperature (e.g., dump temperature) of the composite can range from 130° C. to 180° C., such as from 140° C. to 170° C. Alternatively, the multi-stage process can be monitored by material temperature, or probe temperature, which is the temperature of the mixture or composite taken or measured immediately upon discharging (within 5 min., within 3 min. or within 60 seconds) and can be considered an average temperature of the composite material.

As an option, any of the methods disclosed herein lends itself to implementation as a unit operation within a multi-unit manufacturing plant, such as a plant for manufacturing/processing of natural rubber in combination with a rubber composite or rubber vulcanizing plant. For instance, the multi-unit manufacturing plant can include a receiving part for receiving latex from tanks loaded on trucks or other vehicle, where this latex is transferred or unloaded into pits (e.g., a series or lines of pits) (or channels or similar holding devices). In these pits, the latex can be treated so as to coagulate the latex and thus become coagulum, such as by adding an acid or salt to the latex. Once coagulated, the coagulum can be optionally subjected to dewatering steps (e.g., squeezing the coagulum with one or more rollers) or the dewatering steps can be skipped, and the coagulum can be transferred to the area of the multi-unit manufacturing plant that processes the starting natural rubber into a rubber composite and ultimately a vulcanized rubber composite, including the mixers, and any post-processing steps.

It can be beneficial to use never-dried natural rubber in the integrated manufacturing option to improve filler incorporation and dispersion and to avoid or reduce the conventional natural rubber drying processes. Advantages of such a multi-unit manufacturing operation include those enumerated herein, together with obtaining a higher quality composite, a streamlined, simplified manufacturing process for producing composites from never-dried natural rubber and significant energy and cost savings.

Since the integrated manufacturing process can utilize a wet natural rubber, the ability to use never-dried natural rubber can potentially create a more efficient operation and may permit a turn-key type of operation. The use of any never-dried natural rubber is possible in such integrated processes as described herein.

The composite may be used to produce natural rubber-containing products. As an option, the elastomer composite may be used in or produced for use, e.g., to form a vulcanizate to be incorporated in various parts of a tire, for example, tire treads, including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

The filler (e.g. wet or dry or both) that is used in the methods disclosed herein can be a solid material, e.g., a solid bulk material, in the form of a powder, paste, pellet or cake. In the methods, the filler can be dispersed in the natural rubber at a loading ranging from 20 phr to 100 phr on a dry weight basis, or a loading ranging from 20 phr to 250 phr, from 20 phr to 200 phr, e.g., from 20 phr to 180 phr, from 20 phr to 150 phr, from 20 phr to 120 phr, or from 20 phr to 100 phr, as well as other ranges disclosed herein.

The filler in general, can be any conventional filler used with elastomers such as reinforcing fillers including, but not limited to, carbon black, silica, a filler comprising carbon black, a filler comprising silica, and/or any combinations thereof. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The filler can comprise at least one material that is selected from carbonaceous materials, carbon black, silica, nanocellulose, lignin, clays, nanoclays, metal oxides, metal carbonates, pyrolysis carbon, reclaimed carbon, recovered carbon black (e.g., as defined in ASTM D8178-19, rCB), graphenes, graphene oxides, reduced graphene oxide (e.g., reduced graphene oxide worms as disclosed in PCT Publ. No. WO 2019/070514A1, or densified reduced graphene oxide granules as disclosed in U.S. Prov. Appl. No. 62/857,296, filed Jun. 5, 2019, and PCT Publ. No. 2020/247681, the disclosures of which are incorporated herein by reference), carbon nanotubes, single-wall carbon nanotubes, multi-wall carbon nanotubes, or combinations thereof, or corresponding coated materials or chemically-treated materials thereof (e.g., chemically-treated carbon black). Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Appl. No. PCT/US2021/027814, the disclosures of which are incorporated by reference herein. Blends of additional fillers can also be used, e.g., blends of silica and carbon black, silica and silicon-treated carbon black, and carbon black and silicon-treated carbon black. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used. More details concerning the filler are provided in other sections herein.

As mentioned previously, fibrous fillers can also be incorporated in the methods disclosed herein, including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly(p-phenylene terephthalamide) pulp, commercially available as Kevlar® pulp (Du Pont).

Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and the disclosures of which are incorporated by reference, herein), rice husk silica, carbon from methane pyrolysis, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure.

The filler can be or include a blend of carbon black and silica in any weight ratio, such as weight ratio ranges of from 1:99 to 99:1 or from 25:75 to 75:25 or from 45:55 to 55:45. As an option, a blend of carbon black and silica can contain at least 1% carbon black (i.e., no more than 99% silica), at least 5% carbon black, at least 10% carbon black, at least 20% carbon black, at least 30% carbon black, at least 50% carbon black, at least 75% carbon black, at least 90% carbon black, at least 95% carbon black, or at least 99% carbon black (i.e., no more than 1% silica).

The amount of filler that is loaded into the mixture can range from 20 phr to 250 phr, 20 phr to 200 phr, 20 phr to 150 phr, 20 phr to 100 phr, 30 phr to 100 phr, 40 phr to 100 phr, 50 phr to 100 phr, 20 phr to 70 phr, 30 phr to 70 phr, 35 phr to 70 phr, 40 phr to 70 phr, 20 phr to 65 phr, 30 phr to 65 phr, 35 phr to 65 phr, 40 phr to 65 phr, 20 phr to 60 phr, 30 phr to 60 phr, 35 phr to 60 phr, 40 phr to 60 phr, 20 phr to 50 phr, or other amounts within or outside of one or more of these ranges. The filler can be any filler disclosed herein, such as carbon black, silica, or silicon-treated carbon black, whether alone or with one or more other fillers.

As an example, the carbon black can be dispersed in the natural rubber at a loading ranging from 30 phr to 70 phr, or from 40 phr to 65 phr, or from 40 phr to 60 phr. As a more specific example, with the elastomer being natural rubber alone or with one or more other elastomers, and the filler being carbon black alone or with one or more other fillers (e.g., silica or silicon-treated carbon black), the carbon black can be dispersed in the natural rubber at a loading ranging from 30 phr to 70 phr, or from 40 phr to 65 phr, or from 40 phr to 60 phr.

For graphenes, graphene oxides, reduced graphene oxide, carbon nanotubes, single-wall carbon nanotubes, multi-wall carbon nanotubes, these fillers can be dispersed in the elastomer at a loading ranging from 1 phr to 100 phr, e.g., from 1 phr to 50 phr, from 1 phr to 25 phr, from 1 phr to 20 phr, or from 1 phr to 10 phr. When combined with other fillers, such as carbon black, the graphenes, graphene oxides, reduced graphene oxide, carbon nanotubes, single-wall carbon nanotubes, and multi-wall carbon nanotubes can be dispersed in the elastomer at a loading ranging from 0.5 phr to 99 phr, e.g., from 0.5 phr to 50 phr, from 0.5 phr to 25 phr, from 0.5 phr to 20 phr, or from 0.5 phr to 10 phr. In such combinations, the graphenes, graphene oxides, reduced graphene oxide, carbon nanotubes, single-wall carbon nanotubes, and multi-wall carbon nanotubes can be present in an amount of at least 1%, at least 2%, at least 5%, at least 10%, at least 15%, at least 20%, at least 30%, at least 40%, or at least 50% by weight of the total amount of filler dispersed in the elastomer.

The carbon black can be untreated carbon black or treated carbon black or a mixture thereof. The filler can be or include carbon black in the form of pellets, fluffy powder, granules, and/or agglomerates. Wet carbon black can be formed into pellets, granules, or agglomerates in, e.g., a pelletizer, a fluidized bed or other equipment to make the wet filler.

The carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have any statistical thickness surface area (STSA) such as ranging from 20 m²/g to 250 m²/g or higher. STSA (statistical thickness surface area) is determined based on ASTM Test Procedure D-5816 (measured by nitrogen adsorption). The carbon black can have a compressed oil absorption number (COAN) ranging from about 30 mL/100 g to about 150 mL/100 g. Compressed oil absorption number (COAN) is determined according to ASTM D3493. As an option, the carbon black can have a STSA ranging from 20 m²/g to 180 m²/g, or from 60 m²/g to 150 m²/g with a COAN ranging from 40 mL/100 g to 115 mL/100 g or from 70 mL/100 g to 115 mL/100 g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure™, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber may be used, such as those described in U.S. Publ. No. 2018/0282523, the disclosure of which is incorporated herein by reference.

The carbon black can be an oxidized carbon black, such as a carbon black that has been surface treated using an oxidizing agent. Oxidizing agents include, but are not limited to, air, oxygen gas, ozone, NO₂ (including mixtures of NO₂ and air), peroxides such as hydrogen peroxide, persulfates, including sodium, potassium, or ammonium persulfate, hypohalites such a sodium hypochlorite, halites, halates, or perhalates (such as sodium chlorite, sodium chlorate, or sodium perchlorate), oxidizing acids such a nitric acid, and transition metal containing oxidants, such as permanganate salts, osmium tetroxide, chromium oxides, or ceric ammonium nitrate. Mixtures of oxidants may be used, particularly mixtures of gaseous oxidants such as oxygen and ozone. In addition, carbon blacks prepared using other surface modification methods to introduce ionic or ionizable groups onto a pigment surface, such as chlorination and sulfonation, may also be used. Processes that can be employed to generate oxidized carbon blacks are known in the art and several types of oxidized carbon black are commercially available.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

The silicon-treated carbon black can include silicon-containing regions primarily at the aggregate surface of the carbon black, but still be part of the carbon black and/or the silicon-treated carbon black can include silicon-containing regions distributed throughout the carbon black aggregate. The silicon-treated carbon black can be oxidized. The silicon-treated carbon black can contain from about 0.1% to about 50% silicon by weight, e.g., from about 0.1% to about 46.6%, from about 0.1% to about 46%, from about to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 5%, or from about 0.1% to about 2% by weight, based on the weight of the silicon-treated carbon black. These amounts can be from about 0.5 wt. % to about 25 wt. %, from about 1 wt. % to about 15 wt. % silicon, from about 2 wt. % to about 10 wt. %, from about 3 wt. % to about 8 wt. %, from about 4 wt. % to about 5 wt. % or to about 6 wt. %, all based on the weight of the silicon-treated carbon black. The amount of silicon-treated carbon black present in the elastomer composite formed can be from 20 phr to 250 phr, from 20 phr to 200 phr, from 30 phr to 150 phr, from 40 phr to 100 phr, or from 50 phr to 65 phr.

One of skill in the art will recognize that, separately from the silicon content of the silicon-treated carbon black, the surface of the particle may also have varying amounts of silica and carbon black. For example, the surface area of the silicon-treated carbon black may include from about 5% to about 95% silica, for example, from about 10% to about 90%, from about 15% to about 80%, from about 20% to about 70%, from about 25% to about 60%, from about 30% to about 50%, or from about 35% to about 40%, for example, up to about 20% or up to about 30% silica. The amount of silica at the surface may be determined by the difference between the surface areas of the particles as measured by iodine number (ASTM D-1510) and nitrogen adsorption (i.e., BET, ASTM D6556).

As another option, the filler, e.g., carbon black, can be chemically treated. For example, the carbon black can have attached at least one organic group. Attachment can occur via a diazonium reaction where the at least one organic group has a diazonium salt substituent as detailed, for instance, in U.S. Pat. Nos. 5,554,739; 5,630,868; 5,672,198; 5,707,432; 5,851,280; 5,885,335; 5,895,522; 5,900,029; 5,922,118, the disclosure of which are incorporated herein by reference.

With regard to the filler, as an option, being at least silica, one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g; about 30 m²/g to about 450 m²/g; about 30 m²/g to about 400 m²/g; or about 60 m²/g to about 250 m²/g, from about 60 m²/g to about 250 m²/g, from about 80 m²/g to about 200 m²/g. The silica can have an STSA ranging from about 80 m²/g to 250 m²/g, such as from about 80 m²/g to 200 m²/g or from 90 m²/g to 200 m²/g, from 80 m²/g to 175 m²/g, or from 80 m²/g to 150 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon® 400, 454, or 458 silica from PPG Industries, Inc. and Coupsil silicas from Evonik Industries, for example Coupsil® 6109 silica.

Any of the silica(s) can be chemically functionalized, such as to have attached or adsorbed chemical groups, such as attached or adsorbed organic groups. Any combination of silica(s) can be used. The silica can be in part or entirely a silica having a hydrophobic surface, which can be a silica that is hydrophobic or a silica that becomes hydrophobic by rendering the surface of the silica hydrophobic by treatment (e.g., chemical treatment). The hydrophobic surface may be obtained by chemically modifying the silica particle with hydrophobizing silanes without ionic groups, e.g., bis-triethoxysilylpropyltetrasulfide. Suitable hydrophobic surface-treated silica particles for use herein may be obtained from commercial sources, such as Agilon® 454 silica and Agilon® 400 silica, from PPG Industries. Silica having low surface silanol density, e.g., silica obtained through dehydroxylation at temperatures over 150° C. via, for example, a calcination process, may be used herein. An intermediate form of silica obtained from a precipitation process in a cake or paste form, without drying (a never-dried silica) may be added directly to a mixer as the wet filler, thus eliminating complex drying and other downstream processing steps used in conventional manufacture of precipitated silicas.

In any embodiment and in any step, a coupling agent can be introduced in any of the steps (or in multiple steps or locations) as long as the coupling agent has an opportunity to become dispersed in the composite. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl)tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi(3-mercapto) propionato-O, N,N′-bis(2-methyl-2-nitropropyl)-1,6-diaminohexane, S-(3-(triethoxysilyl)propyl) octanethioate (e.g., NXT coupling agent from Momentive, Friendly, WV), and/or coupling agents that are chemically similar or that have the one or more of the same chemical groups. Additional specific examples of coupling agents, by commercial names, include, but are not limited to, VP Si 363 from Evonik Industries, and NXT Z and NXT Z-50 silanes from Momentive. Other compounds that can function as coupling agents include those compounds having a nitroxide radical, e.g., TEMPO (2,2,6,6-tetramethyl-1-piperidinyloxy radical), as disclosed in U.S. Pat. Nos. 6,084,015, 6,194,509, 8,584,725, and U.S. Publ. No. 2009/0292044, the disclosures of which are incorporated by reference herein, or nitrile oxide, nitrile imine and nitrone 1,3-dipolar compounds, as disclosed in U.S. Pat. Nos. 10,239,971, 10,202,471, 10,787,471, and U.S. Publ. No. 2020/0362139, the disclosures of which are incorporated by reference herein. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounder.

As another option, the mixing (e.g., where the filler comprises silica and/or silicon-treated carbon black) can be performed without coupling agents.

The amount of silica (in parts per hundred of rubber, or phr) present in the elastomer composite formed can be from 20 phr to 250 phr, from 20 phr to 200 phr, from 20 phr to 150 phr, from 20 phr to from 100 phr, from 30 phr to from 150 phr, from 30 phr to from 100 phr, from 25 phr to 100 phr, from 25 phr to 80 phr, from 35 phr to 115 phr, from 35 phr to 100 phr, from 40 phr to 110 phr, from 40 phr to 100 phr, from about 40 phr to 90 phr, from 40 phr to 80 phr, and the like. Filler blends comprising silica can include 10 wt. % carbon black and/or silicon-treated carbon black.

If a wet filler is selected, a wet filler that can be used in the methods herein, such as a wet carbon black, wet silica, or wet silicon-treated carbon black (described in further detail herein), can be described with respect to a liquid content determined as a function of its oil absorption number (OAN) of the filler, where OAN is determined based on ASTM D2414. A wet filler such as a wet carbon black can be used herein according to the equation: k*OAN/(100+OAN)*100, wherein k ranges from 0.3 to 1.1, or from 0.5 to 1.05, or from 0.6 to 1.1, or from 0.7 to 1.1, or from 0.8 to 1.1, or from 0.9 to 1.1, or from 0.6 to 1.0, or from 0.7 to 1.0, or from 0.8 to 1.0, or from 0.8 to 1.05, or from 0.9 to 1.0, or from to 1, or from 0.95 to 1.1, or from 1.0 to 1.1.

As a more specific example, if selected, such a wet filler having this type of ‘wet’ form as a solid can contain, for instance, up to 80% by weight liquid (e.g., water and/or other aqueous liquid) based on the total weight of the wet filler. The wet filler can have a liquid content (e.g., water content) of 80% by weight or less, such as 70% or less, 60% or less, 50% or less, 40% or less, 30% or less, such as from about 15% to about 80%, from about 20 wt % to about 80%, from about 25% to about 80%, from about 30% to about 80%, from about 35% to about 80%, from about 40% to about 80%, from about 15 wt. % to about 70%, from about 20 wt. % to about 70%, from about 25 wt % to 70%, from about 30% to 70%, from about 35% to about 70%, from about 40% to 70%, from about 15 wt. % to about 65%, from about 20% to about 65 wt %, from about 25 wt % to about 65 wt %, from about 30 wt % to about 65 wt %, from about 35 wt % to about 65 wt %, from about 40 wt % to about 65 wt %, from about 15% to about 60%, from about 20 wt % to about 60 wt %, from about 25 wt % to about 60 wt %, from about 30 wt % to about 60 wt %, from about 35 wt % to about 60 wt %, from about 40 wt % to 60 wt %, or any other ranges from these various values given herein.

As a more specific example, a wet carbon black can have a liquid content ranging from about 20% to about 70% by weight, relative to the total weight of the wet carbon black, e.g., from about 25% to about 70%, from about 30% to about 70%, from about 35% to about 70%, from about 40% to about 70%, from about 45% to about 70%, from about 50% to about 70%, from about 20% to about 65% by weight.

While the liquid amount in the filler as described above can equally apply to silica, as a more particular example, when silica is used as the wet filler (if this option is used) in part or in whole as the wet filler, the silica can have liquid present in an amount of from about 25 wt % to about 75 wt %, e.g., from about 30% to about 75%, from about 40% to about 75%, from about 45% to about 75%, from about 50% to about 75%, from about 30% to about 70%, from about 40% to about 70%, from about 45% to about 70%, from about 50% to about 70%, from about 30% to about 65%, from about 40% to about 65%, from about 45% to about 65%, from about 50% to about 65%, from about 30% to about 60% by weight, from about 40% to about 60%, from about 45% to about 60%, or from about 50% to about 60%, based on the weight of the total wet filler or based on the weight of just the wet silica present.

The wet carbon black, if used, can be one or more of the following:
never-dried carbon black; and/or
never-dried carbon black pellets; and/or
dried carbon black pellets that have been rewetted, such as with water in a pelletizer; and/or
dried carbon black pellets that have been ground and then rewetted with water in a pelletizer; and/or
dried carbon black pellets combined with water; and/or
fluffy powder, granules, or agglomerates combined with water.

The composites prepared by any of the methods disclosed herein can consist of natural rubber and filler, i.e., no rubber chemicals are present. Alternatively, in addition to filler and natural rubber, the composite can comprise at least one additive selected from anti-degradants and coupling agents. Alternatively, the composites can include one or more rubber chemicals. In another alternative, the composite can be curative-bearing compositions.

Additives can also be incorporated in mixing and/or compounding steps; typical additives include anti-degradants, coupling agents, and one or more rubber chemicals to enable dispersion of filler into the elastomer. Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limit to, retarders, co-agents, peptizers, adhesion promoters (e.g., use of cobalt salts to promote adhesion of steel cord to rubber-based elastomers (e.g., as described in U.S. Pat. No. 5,221,559 and U.S. Pat. Publ. No. 2020/0361242, the disclosures of which are incorporated by reference herein), resins (e.g., tackifiers, traction resins), flame retardants, colorants, blowing agents, and additives to reduce heat build-up (HBU), and linking agents such as those described in U.S. Prov. Appl. No. 63/123,386, the disclosure of which is incorporated by reference herein. As an option, the rubber chemicals can comprise processing aids and activators. As another option, the one or more other rubber chemicals are selected from zinc oxide, fatty acids, zinc salts of fatty acids, wax, accelerators, resins, and processing oil. Exemplary resins include those selected from one or more of C5 resins, C5-C9 resins, C9 resins, rosin resins, terpene resins, aromatic-modified terpene resins, dicyclopentadiene resins, alkylphenol resins, and resins disclosed in U.S. Pat. Nos. 10,738,178, 10,745,545, and U.S. Pat. Publ. No. 2015/0283854, the disclosures of which are incorporated by reference herein.

At least one additive can be included during the mixing method described herein or can be included after the composite is formed. The at least one additive can include a curative package or at least one curing agent. To create a vulcanizable composite, the curative package added can include a cross-linking agent, and any activators and accelerators. Where sulfur is used as a cross-linking agent, typical activators include zinc oxide and or stearic acid, and typical accelerators include sulfenamides such as N-tert-butyl-2-benzothiazole sulfenamide (TBBS) and N-cyclohexyl-2-benzothiazole sulfenamide (CBS). Other curatives used in rubber processing are peroxides, urethane crosslinkers, metallic oxides, acetoxysilane compounds, phenolic resins and so forth. Additional suitable components for sulfur-based and other cross-linking systems are well known to those of skill in the art.

Other rubber chemicals include anti-oxidants, processing aids, extender oils, wax, a variety of resins, coupling agents, and additional antidegradants. Antioxidants include N-(1,3-dimethylbutyl)-N′-phenyl-p-phenylenediamine (6PPD) and those listed in WO2012/037244, the disclosure of which is incorporated herein by reference.

As an option, rubber chemicals can be combined with the composite in a mechanical mixer. Specifically, additives such as filler (which may be the same as, or different from, the filler used in the mixer; exemplary fillers include silica, carbon black, and/or zinc oxide), other elastomers, other or additional masterbatch, antidegradants (e.g., antioxidants), coupling agents, plasticizers, processing aids (e.g., stearic acid, which can also be used as a curing agent, liquid polymers, oils, waxes, and the like), resins, flame-retardants, extender oils, and/or lubricants, and a mixture of any of them, can be added in a mechanical mixer.

The antidegradant (an example of a degradation inhibitor) can be an amine type anti-degradant, phenol type anti-degradant, imidazole type anti-degradant, metal salt of carbamate, para-phenylene diamine(s) and/or dihydrotrimethylquinoline(s), polymerized quinine antidegradant, and/or wax and/or other antidegradants used in elastomer formulations. Specific examples include, but are not limited to, N-(1,3-dimethylbutyl)-N′-phenyl-p-phenylenediamine (6-PPD, e.g., ANTIGENE 6C, available from Sumitomo Chemical Co., Ltd. and NOCLAC 6C, available from Ouchi Shinko Chemical Industrial Co., Ltd.), “Ozonon” 6C from Seiko Chemical Co., Ltd., polymerized 1,2-dihydro-2,2,4-trimethyl quinoline (TMQ, e.g., Agerite Resin D, available from R. T. Vanderbilt), 2,6-di-t-butyl-4-methylphenol (available as Vanox PC from Vanderbilt Chemicals LLC), butylhydroxytoluene (BHT), and butylhydroxyanisole (BHA), and the like. Other representative antidegradants may be, for example, diphenyl-p-phenylenediamine and others such as, for example, those disclosed in The Vanderbilt Rubber Handbook (1978), pages 344-346.

As an option, where the filler comprises carbon black, an agent can be charged to the mixer (as a separate charge from the filler, with the filler, as a co-pellet, etc.). Without wishing to be bound by any theory, the agent can improve dispersion of the filler. The agent can be selected from one or more compounds as disclosed in U.S. Prov. Appl. Nos. 63/123,386 and 63/123,391, the disclosures of which are incorporated by reference herein.

Particular types of internal mixers are a Banbury mixer or a Brabender mixer, either of which can be used for the methods of forming a composite described herein. The internal mixer can be a tangential internal mixer. The internal mixer can be an intermeshing internal mixer. Other mixers include a kneading type internal mixer. Commercially available internal mixers from Farrel-Pomini, Harburg Freudenberger Maschinenbau GmbH (HF), Kobelco, or Pelmar Eng'r Ltd can be used. Besides the option to use inner circuits of steam or water or other fluid in the rotors, in addition or alternatively, the internal mixer can have cooling or heating jackets at one region or part or more than one region or part of the mixing chamber to control the temperature of the components being mixed therein. This can create one or more heating/cooling zones in a wall or portion of a wall of a mixer. The mixer can be a single stage mixer or a multi-stage mixer (e.g., two stages or more). Examples of mixers and designs that can be utilized are described in European Patent No. 2423253B1 and U.S. Pat. No. 7,556,419, the disclosures of which are incorporated herein by reference.

As another option, the mixer can be a continuous mixer. For example, the wet natural rubber and filler may be mechanically worked by using one or more of a continuous internal mixer, a twin-screw extruder, a single screw extruder, or a roll mill, such as those described in U.S. Pat. No. 9,855,686 B2, the disclosure of which is incorporated herein by reference. Suitable kneading and masticating devices are well known and commercially available, including for example, a Unimix Continuous Mixer and MVX (Mixing, Venting, eXtruding) Machine from Farrel Pomini Corporation of Ansonia, Conn., an FCM™ Farrel Continuous Mixer, a long continuous mixer from Pomini, Inc., a Pomini Continuous Mixer, twin rotor corotating intermeshing extruders, twin rotor counterrotating non-intermeshing extruders, continuous compounding extruders, the biaxial milling extruder produced by Kobe Steel, Ltd., and a Kobe Continuous Mixer. Alternative masticating apparatus suitable for use with one or more embodiments disclosed herein will be familiar to those of skill in the art.

The mixing can be performed with a mixer(s) having at least one rotor and the mixer can be one or more of the following: a kneader, a roll mill, a screw extruder, a twin-screw extruder, a multiple-screw extruder, a continuous compounder, and/or a twin-screw extruder.

The mixing can be performed with a mixer(s) having at least one rotor and the mixer can have two-wing rotors, four-wing rotors, six-wing rotors, eight-wing rotors, and/or one or more screw rotors.

The composite that is discharged can be subjected to one or more post-processing steps. Post-processing can be performed after any mixing step. For a multi-stage mix, post-processing can be performed after the first stage and/or after the second stage and so on. The composite can be post-processed to provide a composite that is dried, homogenized, extruded, calendared, milled, etc. One or more post-processing steps can shape or form or can allow for improved handling but preferably does not substantially disperse the filler. For example, the one or more post-processing steps can impart at most small amounts of energy, e.g., less than 300 kJ/kg composite, less than 200 kJ/kg composite, less than 100 kJ/kg composite, or less than 50 kJ/kg composite. For example, the one or more post-processing steps does not result in significant temperature rise of the composite (as a result of the low energy input).

As an option, the water content of the discharged composite can be 5% by weight or lower when discharged and this water content can be further reduced by one or more additional water or liquid (if using a wet filler) removal steps, such as the use of a further mixing step(s), a compounding step(s), a dryer, or the application of heat, or other means to remove water and optionally other liquids from a mixture, so as to achieve the desired water content of the composite. In general, the post processing steps can remove from 1% to about 90%, e.g., from 1% to about 50%, of any remaining liquid phase.

In any method of producing a composite disclosed herein, the method can further include one or more of the following steps, after formation of the composite:
one or more holding steps;
one or more drying steps can be used to further dry the composite to obtain a dried composite;
one or more extruding steps;
one or more calendaring steps;
one or more milling steps to obtain a milled composite;
one or more granulating steps;
one or more cutting steps;
one or more baling steps to obtain a bailed product or mixture;
the baled mixture or product can be broken apart to form a granulated mixture; and/or
one or more mixing or compounding steps; and/or
one or more sheeting steps.

The one or more processing steps can be achieved with one or more of an internal mixer, a kneader, a roll mill, a screw extruder, a twin-screw extruder, a multiple-screw extruder, a continuous compounder, and/or a twin-screw screw discharge extruder fitted with a roller die (e.g., twin-screw sheeter) or fitted with stationary knives.

As a further example, the following sequence of steps can occur and each step can be repeated any number of times (with the same or different settings), after formation of the composite:
one or more holding steps to develop further elasticity
one or more cooling steps
drying the composite further to obtain a further dried composite;
mixing or compounding the composite to obtain a compounded mixture;
milling the compounded mixture to obtain a milled mixture (e.g., roll milling);
granulating the milled mixture;
optionally baling the mixture after the granulating to obtain a baled mixture;
optionally breaking apart the baled mixture and mixing.

As an option, the composite can be further processed on an open mill. The composite can be discharged from a continuous compounder or extruder as a length of extrudate and may be cut into smaller lengths prior to entering the open mill. The composite may optionally be fed to the open mill via a conveyor. The conveyor may be a conveyor belt, conduit, pipe, or other suitable means for transporting the composite from a continuous compounder to an open mill. The open mill can include a pair of rollers that may optionally be heated or cooled to provide enhanced operation of the open mill. Other operating parameters of the open mill can include the gap distance between the rolls, the bank height, i.e., the reservoir of material in the gap between and on top of the rolls, and the speed of each roll. The speed of each roll and the temperature of the fluid used to cool each roll may be controlled independently for each roll. The gap distance may be from about 3 mm to about 10 mm or from about 6 mm to about 8 mm. The roll speed may be about 15 rpm to about 70 rpm, and the rollers may roll towards one another with respect to the inlet side of the mill. The friction ratio, the ratio of the speed of the collection roller, e.g., the roller on which the masticated product collects, to that of the back roller, may be from about 0.9 to about 1.1. The fluid employed to cool the rollers may be from about 35° C. to about 90° C., for example, from about 45° C. to about 60° C., from about 55° C. to about 75° C., or from about 70° C. to about 80° C. In addition to controlling the operation of the open mill to provide a desired level of mastication and desiccation to the masticated product, it is also desirable that the output of the open mill should collect on the collection roller as a smooth sheet. The residence time of the composite in the mill can be determined in part by the roller speed, the gap distance and the amount of mastication and drying desired and may be about 10 minutes to about 20 minutes for material that has already been masticated, for example, in a twin-rotor continuous mixer.

One skilled in the art will recognize that different combinations of devices may be employed. Depending on which devices are used, it may be desirable to operate them under different conditions than those described above to impart varying amounts of work and/or further desiccation to the material. In addition, it may be desirable to employ more than one particular kind of device, e.g., an open mill or internal mixer, in series or to pass masticated product through a given device more than one time. For example, the composite may be passed through an open mill two or three or more times or passed through two or three or more open mills in series. In the latter case, it may be desirable to operate each open mill under different operating conditions, e.g., speed, temperature, different (e.g. higher) energy input, etc. The composite can be passed through one, two, or three open mills after being mixed in an internal mixer.

In addition, or alternatively, the composite can be compounded with one or more antidegradants, rubber chemicals, and/or curing agents, and vulcanized to form a vulcanizate. Such vulcanized compounds can have one or more improved properties, such as one or more improved rubber properties, such as, but not limited to, an improved hysteresis, wear resistance and/or rolling resistance, e.g., in tires, or improved mechanical and/or tensile strength, or an improved tan delta and/or an improved tensile stress ratio, and the like.

As an example, in a compounding step (which also can be the initial mixing step), the ingredients of the curative package, with the exception of the sulfur or other cross-linking agent and accelerator, are combined with the neat composite in a mixing apparatus (the non-curatives, e.g., rubber chemicals and/or antidegradants, are often pre-mixed and collectively termed “smalls”). The most common mixing apparatus is the internal mixer, e.g., the Banbury mixer, but other mixers, such as continuous mixers (e.g., extruders), may also be employed. Thereafter, in a latter or second compounding step, the cross-linking agent, e.g., sulfur, and accelerator (if necessary) (collectively termed curatives) are added. As another option, the compounding can comprise combining the composite with one or more of antidegradants, zinc oxide, fatty acids, zinc salts of fatty acids, wax, accelerators, resins, processing oil, and curing agents in a single compounding stage or step, e.g., the curatives can be added with smalls in the same compounding stage. The compounding step is frequently performed in the same type of apparatus as the mixing step but may be performed on a different type of mixer or extruder or on a roll mill. One of skill in the art will recognize that, once the curatives have been added, vulcanization will commence once the proper activation conditions for the cross-linking agent are achieved. Thus, where sulfur is used, the temperature during mixing is preferably maintained substantially below the cure temperature.

Also disclosed herein are methods of making a vulcanizate. The method can include the steps of at least curing a composite in the presence of at least one curing agent. Curing can be accomplished by applying heat, pressure, or both, as known in the art.

As an option, vulcanizates prepared from the present composites (e.g., those made by any of the presently disclosed processes between filler and never-dried natural rubber) can show improved properties. For example, vulcanizates prepared from the present composites can have improved properties over a vulcanizate prepared from a composite made by mixing solid elastomer and filler (“dry mix composite”), particularly those dry mix composites having the same composition (“dry mix equivalent”). Thus, the comparison is made between dry mixes and the present mixing processes between comparable fillers, elastomers, filler loading (e.g., ±5 wt %, ±2 wt. %), and compound formulation, and optionally curing additives. Under these conditions, the vulcanizate has a tan δ value that is less than a tan δ value of a vulcanizate prepared from a dry mix composite having the same composition. In addition to or in the alternative, the vulcanizate has a tensile stress ratio, M300/M100, that is greater than a tensile stress ratio of a vulcanizate prepared from a dry mix composite having the same composition, wherein M100 and M300 refer to the tensile stress at 100% and 300% elongation, respectively.

Also disclosed herein are articles made from or containing the composite or vulcanizates disclosed herein.

The composite may be used to produce an elastomer or rubber containing product. As an option, the elastomer composite may be used in or produced for use, e.g., to form a vulcanizate to be incorporated in various parts of a tire, for example, tire treads (such as on road or off-road tire treads), including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

Accordingly, articles include vehicle tire treads including cap and base, sidewalls, undertreads, innerliners, wire skim components, tire carcasses, engine mounts, bushings, conveyor belt, anti-vibration devices, weather stripping, windshield wipers, automotive components, seals, gaskets, hoses, liners, pads, housings, and wheel or track elements. For example, the article can be a multi-component tread, as disclosed in U.S. Pat. Nos. 9,713,541, 9,713,542, 9,718,313, and 10,308,073, the disclosures of which are incorporated herein by reference.

Where applicable, the present methods can incorporate suitable fillers, elastomers, mixing and compounding methods, composites, vulcanizates, additives, mixers, and other disclosures described in PCT Publ. No. WO 2020/247663, the disclosure of which is incorporated by reference herein.

### EXAMPLES

The Examples describe the preparation of elastomer composite and corresponding vulcanizates from never-dried natural rubber with several particulate fillers along with comparative composites prepared in a similar manner but from dried natural rubber.

All mixing and compounding processes were performed with a BR-1600 Banbury® mixer (“BR1600”; Manufacturer: Farrell). The BR1600 mixer was operated with two 2-wing, tangential rotors (2WL), providing a capacity of 1.6 L.

Water content in the discharged composite was measured using a moisture balance (Model: HE53, Manufacturer: Mettler Toledo NA, Ohio). The composite was sliced into small pieces (size: length, width, height<5 mm) and 2 to 2.5 g of material was placed on a disposable aluminum disc/plate which was placed inside the moisture balance. Weight loss was recorded for 30 mins at 125° C. At the end of 30 mins, moisture content for the composite was recorded as:

$$moisture content of composite = ( \frac{initial weight - final weight}{initial weight} ) * 10 \; 0 .$$

The carbon black loading in the composite was determined by Thermogravimetric Analysis (Model Q500 unit, Manufacturer: TA Instruments, DE). About 15-20 mg of rubber samples were used. Samples were first heated under nitrogen atmosphere from room temperature to 125° C. at 30° C./min and isothermal for 30 min to remove moisture, then heated to 550° C. at 30° C./min and isothermal for 5 min to determine the organic content, which is primarily the rubber content. After that the atmosphere was switched to air, samples were then heated to 800° C. at 30° C./min and isothermal for 15 min to determine carbon black (CB) content. The CB loadings were then calculated as carbon black content divided by organic content.

The following tests were used to measure rubber properties on each of the vulcanizates:
Tensile stress at 100% elongation (M100) and tensile stress at 300% elongation (M300) were evaluated by ASTM D412 (Test Method A, Die C) at 23° C., 50% relative humidity and at crosshead speed of 500 mm/min. Extensometers were used to measure tensile strain. The ratio of M300/M100 is referred to as tensile stress ratio (or modulus ratio).
Max tan δ was measured with an ARES-G2 rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60′C and at constant frequency of 10 Hz. Strain sweeps were run from 0.1-68% strain amplitude. Measurements were taken at ten points per decade and the maximum measured tan δ (“max tan δ”) was recorded, also referred to as “tan δ” unless specified otherwise.

### Compounding Procedures

To convert composites to vulcanizable products, either one or two additional mixing stages were carried out. These procedures were the same for all inventive and comparative examples. If two mixing stages were applied, a first mixing method is outlined in Table 1:

TABLE 1
Fill factor 68%; TCU = 50° C.; 80 rpm; ram pressure = 2.8 bar

| Time (s) | Description |
|---|---|
| 0 | Add composite |
| 180 | Dump |

The final stage mixing method for all compounds is outlined in Table 2:

TABLE 2
Fill factor 65%; TCU = 50° C.; 60 rpm; ram pressure = 2.8 bar

| Time (s) | Description |
|---|---|
| 0 | Add composite and curatives |
| 30 | Sweep |
| 60 | Dump |

After each mixing stage, the composites were sheeted on a 2-roll mill operated at 50′C and about 37 rpm, followed by four pass-throughs with a nip gap about 5 mm, with a rest time before next stage of mixing of at least 3 hours.

Final compounds were cured in a heated press at 150° C. for a time, T90+10% of T90, where T90 is the time to achieve 90% vulcanization, determined by a conventional rubber rheometer.

### Examples 1 and 2: Natural Rubber/N234 Carbon Black

These Examples describe the preparation of composites and corresponding vulcanizates from never-dried natural rubber via a batch mixing process, as compared with composites and vulcanizates prepared from solid natural rubber.

The never-dried natural rubber used in Examples 1 and 2 was obtained from Hokson Rubber, Malaysia. The never-dried natural rubber was a natural latex that was naturally coagulated in air and harvested directly from the tree to obtain a natural rubber coagulum in the form of lumps (cup lumps). This coagulum was washed with water to remove some of the impurities present resulting in a coagulum having a 27 wt % water based on the weight of the coagulum.

The filler used for Examples 1 and 2 and the comparative examples was Vulcan® 7H carbon black (N234) from Cabot Corporation.

Examples 1 and 2 were mixed according to the procedure outlined in Table 3, in which the listed time intervals refer to the time period from the start of the mixing, defined as “0 s.”

TABLE 3
Fill factor 70%; TCU = 100° C.; 80 rpm; ram pressure = 2.8 bar

| Time (s) | Description |
|---|---|
| 0 | Add ⅔ Polymer and ⅔ Filler |
| 180 | Add ⅓ Polymer and ⅓ Filler |
| 210 | Sweep/Scrape |
| 375 | Add 6PPD, ZnO and stearic acid |
| | Scrape/Sweep at 140° C. |
| | Dump at 150° C. |

For the comparative examples, the solid dry natural rubber was SMR 20 with a moisture content of <1 wt % (Hokson Rubber, Malaysia). (As a note, if the starting coagulum of Examples 1 and 2 had been fully dried and baled, it would be considered an SMR 20 natural rubber grade). Technical descriptions of this natural rubber are widely available, such as in Rubber World Magazine's Blue Book published by Lippincott and Peto, Inc. (Akron, Ohio, USA).

Comparative Examples C1 and C2 were mixed according to the procedure outlined in Table 4.

TABLE 4
Fill factor 70%; TCU = 50° C.; 80 rpm; ram pressure = 2.8 bar

| Time (s) | Description |
|---|---|
| 0 | Add Polymer |
| 30 | Add ¾ Filler |
| 60 | Add ¼ Filler |
| 180 | Add 6PPD, ZnO and stearic acid |
| 240 | Scrape/Sweep |
| 300 | Dump |

The formulation used in Examples 1 and 2 and Comparative Examples C1 and C2 is Formulation 1 given in Table 5. 6PPD was N-(1,3-dimethylbutyl)-N′-phenyl-p-phenylenediamine, zinc oxide, stearic acid and sulfur were standard rubber grades, and CBS (N-cyclohexyl-2-benzothiazole sulfenamide) was Accelerator CBTS, all available from Akrochem, Akron, Ohio.

TABLE 5

| | |
|---|---|
| Formulation 1 (phr) | Formulation 2 (phr) |

| | | | | |
|---|---|---|---|---|
| | NR | 100 | NR | 100 |
| | CB | var | CB | var |
| “smalls” | 6PPD | 2 | 6PPD | 1.5 |
| | Zinc Oxide | 3 | Zinc Oxide | 5.0 |
| | Stearic Acid | 2.5 | Stearic Acid | 3.0 |
| | | | Wax beads | 1.5 |
| | | | Process oil | 2.5 |
| Curatives | CBS | 1.2 | TBBS | 1.4 |
| | Sulfur | 1.2 | Sulfur | 1.2 |

Table 6 provides additional properties of the composite prior to compounding as well as rubber properties of the corresponding vulcanizates. “Water in starting rubber” refers to the amount of water in the coagulum, for Examples 1 and 2, or the solid natural rubber of Comparative Examples C1 and C2.

TABLE 6

| | Example | Example | Comparative | Comparative |
|---|---|---|---|---|
| | 1 | 2 | C1 | C2 |
| Water in starting | 27 | 27 | <1 | <1 |
| rubber (%) | | | | |
| Stage 1 mixing | 486 | 445 | 300 | 300 |
| time (s) | | | | |
| Water content of | 1.4 | 1.0 | 0.4 | 0.8 |
| composite | | | | |
| after stage 1 (%) | | | | |
| Total number of | 2 | 3 | 2 | 3 |
| mixing stages | | | | |
| Final CB | 45 | 46 | 47 | 48 |
| content (phr) | | | | |
| M100 (MPa) | 2.22 | 2.18 | 2.66 | 2.60 |
| M300 (MPa) | 13.5 | 13.6 | 14.0 | 14.3 |
| M300/M100 | 6.09 | 6.23 | 5.26 | 5.48 |
| Tan δ(max) | 0.165 | 0.176 | 0.192 | 0.199 |

From the data of Table 6, it can be seen that vulcanizates prepared from the composites prepared by the claimed processes show: (a) higher tensile stress ratio (M300/M100), and (b) lower tan δ compared to the dry mix comparative examples C1 and C2.

### Examples 3 and 4: Natural Rubber/N134 Carbon Black

These Examples describe the preparation of composites and corresponding vulcanizates from never-dried natural rubber via a batch mixing process, as compared with composites and vulcanizates prepared from solid natural rubber.

The never-dried natural rubber used in these examples and the dry natural rubber used for the comparative example (Comparative Example C3) were the same as used in Examples 1 and 2, and Comparative Examples C1 and C2, respectively.

The filler used in these Examples was VULCAN® 10H carbon black (N134) dried pellets from Cabot Corporation. For Example 4, the carbon black was wetted with water. To produce wet carbon black, approximately 1 kg of the carbon black was immersed in an excess of water, and reduced pressure (vacuum) was applied to the head space above the water-carbon black mixture to remove trapped air. After all air had been removed, the excess water was drained off using a coarse filter, and the residual wet pellets were surface-dried in an oven set at 105° C. until the moisture content of the wet pellets reached about 50% by weight. The wet pellets were then removed from the oven and cooled.

In Examples 3 and 4, a 3-stage mixing process as described in Tables 1, 3 and 4 was used, and Formulation 2 of Table 5 was applied. The wax was Sunproof™ Improved wax, the oil was Calight RPO oil, and TBBS (N-tert-butyl-2 benzothiazole sulfenamide) was Accelerator BBTS, all available from Akrochem, Akron, Ohio. In Comparative Example C3, mixing procedures described in Tables 2, 3 and 4 were used, and Formulation 2 in Table 5 was applied.

Table 7 provides additional properties of the composite prior to compounding as well as rubber properties of the corresponding vulcanizates. “Water in starting rubber” refers to the amount of water in the coagulum, for Examples 3 and 4, or the solid natural rubber of Comparative Example C3.

TABLE 7

| | Example | Example | Comparative |
|---|---|---|---|
| | 3 | 4 | C3 |
| Water in rubber (%) | 27 | 27 | <1 |
| Water content of carbon black (%) | <1 | 52 | <1 |
| Stage 1 mixing time (s) | 445 | 910 | 300 |
| Final CB content (phr) | 48 | 50 | 49 |
| M100 (MPa) | 2.03 | 2.74 | 2.23 |
| M300 (MPa) | 11.75 | 16.37 | 12.92 |
| M300/M100 | 5.79 | 5.97 | 5.79 |
| Tan δ(max) | 0.161 | 0.169 | 0.196 |

From the data of Table 7, it can be seen that vulcanizates prepared from the composites prepared by the claimed processes show: (a) equal or higher tensile stress ratio (M300/M100), and (b) lower tan δ compared to the dry mix Comparative Example C3.

### Examples 5 and 6: Natural Rubber/N134 Carbon Black

These Examples describe the preparation of composites and corresponding vulcanizates from never-dried natural rubber and wet carbon black pellets via a continuous mixing process, as compared with composites and vulcanizates prepared from dry carbon black and solid natural rubber.

The never-dried rubber used in Examples 5 and 6 was obtained from Hokson Rubber, Malaysia. The never-dried natural rubber was a natural latex that was naturally coagulated in air and harvested directly from the tree to obtain a natural rubber coagulum in the form of lumps (cup lumps). This coagulum was washed with water and granulated, resulting in a never-dried rubber having 25 wt % water based on the weight of the coagulum.

The carbon black used in Examples 5 and 6 was Vulcan® 10H carbon black (N134) from Cabot Corporation that was obtained after the pelletization step in the normal carbon black manufacturing process, but before the drying step. Some reduction in water content of these pellets occurred during handling, packaging and transportation. The final water content of the wet pellets used in Examples 5 and 6 was 42% by weight.

For Examples 5 and 6, the never-dried natural rubber was fed to the feed hopper of a dewatering screw press (French Oil Mill Machinery Company, Piqua, OH) at a rate of 300 kg/h. The wet carbon black pellets were continuously fed to the same feed hopper using a screw feeding device. After exiting the mill, the rubber-carbon black mixture still contained >10% water at that point. This mixture was conveyed to the feed hopper of an FCM™ mixer (Farrel continuous mixer from Farrel Pomini equipped with #7 and #15 rotors) and subjected to intensive mixing at 300 RPM, resulting in a rapid temperature rise to about 140° C. After exiting the continuous mixer, the composite was conveyed to a 2-roll mill which homogenized, cooled, and sheeted the material. The composite was removed from the roll mill as strips.

For Comparative Examples C4 and C5, the dry rubber used was SMR 5 natural rubber. (As a note, if the starting coagulum of Examples 5 and 6 had been fully dried and baled, it would be considered an SMR 5 natural rubber grade). Technical descriptions of this natural rubber are widely available, such as in Rubber World Magazine's Blue Book published by Lippincott and Peto, Inc. (Akron, Ohio, USA). The carbon black used was Vulcan® 10H carbon black. Mixing was performed as a batch process carried out using the procedure described in Table 4.

To produce vulcanized compounds from the composites produced in Examples 5 and 6 and Comparative Examples C4 and C5, the composites were mixed in a single stage using the procedure given in Table 8 and Formulation 1 in Table 5. Table 9 provides additional properties of the composite prior to compounding and rubber properties of the corresponding vulcanizates. “Water in starting rubber” refers to the amount of water in the coagulum, for Examples 5 and 6, or the solid natural rubber of Comparative Examples C4 and C5.

TABLE 8
Fill factor 70%; TCU = 50° C.; 60 rpm; ram pressure = 2.8 bar

| Time (s) | Description |
|---|---|
| 0 | Add composite |
| 15 | Add 6PPD, ZnO and stearic acid |
| 90 | Add curatives |
| 120 | Scrape/Sweep |
| 150 | Dump |

TABLE 9

| | Example | Example | Comparative | Comparative |
|---|---|---|---|---|
| | 5 | 6 | C4 | C5 |
| Water in starting | 25 | 25 | <1 | <1 |
| rubber (%) | | | | |
| Water content of | 42 | 42 | <1 | <1 |
| Carbon Black (%) | | | | |
| Water content | 2.4 | 2.7 | 0.5 | 0.5 |
| of composite | | | | |
| after stage 1 (%) | | | | |
| Total number of | 2 | 2 | 2 | 2 |
| mixing stages | | | | |
| Final CB | 32 | 38 | 32 | 38 |
| content (phr) | | | | |
| M100 (MPa) | 1.8 | 2.1 | 1.5 | 1.8 |
| M300 (MPa) | 10.6 | 12.5 | 8.6 | 10.3 |
| M300/M100 | 6.06 | 5.96 | 5.73 | 5.74 |
| Tan δ(max) | 0.091 | 0.125 | 0.124 | 0.138 |

From the data of Table 9, it can be seen that vulcanizates prepared from the composites prepared by the claimed processes show: (a) equal or higher tensile stress ratio (M300/M100), and (b) lower tan δ compared to the dry mix comparative examples C4 and C5.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method of preparing a composite, comprising:
(a) charging a mixer separately with at least a never-dried natural rubber and a filler, wherein the never-dried natural rubber has water present in an amount ranging from 5% to 55% by weight of the never-dried natural rubber;
(b) in one or more mixing steps, mixing the at least the never-dried natural rubber and the filler to form a mixture, wherein in at least one of said mixing steps conducting said mixing at mixer temperatures controlled by at least one temperature-control means, and removing at least a portion of the water from the mixture by evaporation; and
(c) discharging, from the mixer, the composite comprising the filler dispersed in the natural rubber at a loading of at least 20 phr, wherein the composite has a water content of no more than 5% by weight based on total weight of said composite.

2. The method of claim 1, wherein the never-dried natural rubber is a coagulum.

3. The method of claim 1, wherein the never-dried natural rubber is a coagulum formed from exposing natural rubber latex to air under ambient conditions.

4. The method of claim 1, wherein the never-dried natural rubber is a coagulum formed from exposing natural rubber latex to a salt or acid or both.

5. The method of claim 1, wherein prior to the charging in step (a), the never-dried natural rubber is washed with water to reduce impurities.

6. The method of claim 1, wherein prior to the charging in step (a), the never-dried natural rubber is subjected to expression, compaction, wringing, or combinations thereof.

7. The method of claim 1, wherein the never-dried natural rubber has said water present in an amount ranging from 10 wt % to 40 wt %.

8. The method of claim 1, wherein the filler is dispersed in the natural rubber at a loading ranging from 20 to 100 phr.

9. The method of claim 1, wherein the filler has a liquid content of less than 10% by weight, based on the weight of the filler, and is in the form of a powder or pellet.

10. The method of claim 1, wherein the filler is a wet filler comprising a filler wetted with a liquid, the wet filler having a liquid content of at least 10% by weight, based on the weight of the wet filler, and is in the form of a powder, paste, pellet, or cake.

11. The method of claim 1, wherein the mixing of the never-dried natural rubber and the filler forms a mixture in the substantial absence of rubber chemicals at mixer temperatures controlled by at least one temperature-control means.

12. The method of claim 1, wherein one or more rubber chemicals are absent from the composite discharged in step (c).

13. The method of claim 1, wherein the composite discharged has a water content of no more than 2% by weight.

14. The method of claim 1, wherein a time period between the start of the mixing and the discharging ranges from 5 min to 30 min.

15. The method of claim 1, wherein during said mixing the mixer has one or more rotors operating at a tip speed of at least 0.5 m/s for at least 50% of the mixing time.

16. The method of claim 1, wherein the filler comprises at least one material selected from carbonaceous materials, carbon black, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, coated and treated filler thereof, and combinations thereof.

17. The method of claim 1, wherein upon charging the mixer with at least a portion of the never-dried natural rubber, the never-dried natural rubber is heated to a temperature of 90° C. or higher prior to charging the mixer with at least a portion of the filler.

18. The method of claim 1, wherein during the charging or mixing, the method further comprises adding at least one antidegradant.

19. The method of claim 1, wherein said mixing is performed in one mixing step.

20. The method of claim 1, wherein said mixing is performed in two mixing steps.

21. The method of claim 1, wherein after said discharging, said method further comprises at least one additional processing step selected from extruding, calendaring, milling, granulating, baling, compounding, and sheeting.

22. A method of preparing a composite in an integrated manufacturing operation, comprising:
a) producing a never-dried natural rubber from latex recovered from natural latex sources in a latex or rubber manufacturing facility;
b) conveying said never-dried natural rubber to at least one mixer;
c) charging said at least one mixer with at least the never-dried natural rubber and at least one filler, wherein the never-dried natural rubber has water present in an amount ranging from 5% to 55% by weight of the never-dried natural rubber;
d) in one or more mixing steps, mixing the at least the never-dried natural rubber and the filler to form a mixture, and in at least one of said mixing steps conducting said mixing at mixer temperatures controlled by at least one temperature-control means, and removing at least a portion of the water from the mixture by evaporation; and
e) discharging, from the at least one mixer, the composite comprising the filler dispersed in the never-dried natural rubber at a loading ranging from 1 to 100 phr, wherein the composite has a water content of no more than 5% by weight based on total weight of said composite.

23. A method of preparing a vulcanizate, comprising:
curing the composite prepare by the method of claim 22 in the presence of at least one curing agent to form the vulcanizate.

24. A tire component or an article comprising the vulcanizate prepared by the method of claim 23.
